(19) United States
(12) Patent Application Publication
(10) Pub. No.: US 2024/0353231 A1
(43) Pub. Date: Oct. 24, 2024

(54) CROSS-ATTENTION PERCEPTION MODEL TRAINED TO USE SENSOR AND/OR MAP DATA

(71) Applicant: Zoox, Inc., Foster City, CA (US)

(72) Inventors: Philippe Martin Burlina, Rockville, MD (US); Subhasis Das, San Mateo, CA (US); Jackson Owen Waschura, Mountain View, CA (US)

(21) Appl. No.: 18/304,975

(22) Filed: Apr. 21, 2023

(51) Int. Cl. G01C 21/32; G06N 20/20

(52) U.S. Cl. CPC G01C 21/32; G06N 20/20

(57) ABSTRACT

A transformer-based machine-learned model may use cross-attention between map data and various sensor data and/or perception data, such as an object detection, to augment perception tasks. In particular, the transformer-based machine-learned model may comprise two or more encoders, one of which may determine a first embedding from map data and a second encoder that may determine a second embedding from sensor data and/or perception data. An encoder may determine a score that may be used to determine various outputs that may improve partially occluded object detection, ground plane classification, static object detection, and suppress false positive object detections.

### BACKGROUND

Some objects may be particularly difficult to detect and/or classify for an autonomous vehicle that uses sensor data to navigate. For example, these objects may include objects that are partially hidden, small debris, objects having a same brightness and/or color as a background, and/or distinguishing and/or locating a ground plane. Moreover, attempts to increase the number of objects detected may result in false positives, like detecting pedestrian shadows or other shadows cast by objects as being discrete objects or detecting steam as being a solid object when, in fact, these aren't objects at all or aren't an object that needs to be avoided by an autonomous vehicle.

Furthermore, some sensors used by an autonomous vehicle may return two-dimensional data alone, leaving the autonomous vehicle without information about how far an object might be from the autonomous vehicle. Techniques for determining a distance from a sensor to an object tend to include specialized hardware, such as using lidar or radar. Inclusion of such specialized hardware introduces new problems and increases computational complexity and latency since sensor fusion may be required to match sensor data from specialized hardware with two-dimensional data received from a different type of sensor, such as a camera.

### BRIEF DESCRIPTION OF THE DRAWINGS

The detailed description is described with reference to the accompanying figures. In the figures, the left-most digit(s) of a reference number identify the figure in which the reference number first appears. The same reference numbers in different figures indicate similar or identical items.

FIG. 1 illustrates an autonomous vehicle and an example scenario illustrating the enhanced capabilities realized by the transformer-based machine-learned architecture that utilizes cross-attention between sensor data and map data as discussed herein.

FIG. 2 illustrates a block diagram of an example system integrating and/or training a transformer-based machine-learned model that utilizes cross-attention between sensor data and map data.

FIG. 3 illustrates a block diagram of part of an example transformer-based machine-learned model architecture with encoders that generate embeddings used for sensor-map cross-attention.

FIG. 4 illustrates an example of patchifying an image into image patches and flattening the image patches into flattened image patches for use by the encoder discussed herein.

FIG. 5 illustrates an example of rendering a two-dimensional representation of map data from map data and patchifying the rendered map data into map patches and embeddings.

FIG. 6 illustrates a block diagram of additional parts of the example transformer-based machine-learned model for determining attention score(s) and using the attention score(s), ML model head(s), and/or decoder(s) to determine various outputs that a vehicle can use to control operations of the vehicle.

FIG. 7 illustrates a block diagram of part of another example transformer-based machine-learned model that may be used to determine a false positive status associated with an object.

FIG. 8 illustrates a block diagram of a remaining portion of the example transformer-based machine-learned model that may be used to determine a false positive status associated with the object.

FIG. 9 illustrates a block diagram of an example transformer-based machine-learned model that generates embedding(s) to associate with geometric data of the map data for use in the techniques described herein, along with a method of training such embedding(s) to increase their usefulness for the techniques discussed herein.

FIGS. 10A-10C depict an example pictorial flow diagram of a method for determining, by the transformer-based machine-learned model discussed herein, a score and/or output(s) for use by a vehicle in controlling one or more operations of the vehicle.

### DETAILED DESCRIPTION

The techniques (e.g., hardware, software, systems, and/or methods) discussed herein may increase the detectability of objects that are difficult to detect or accurately classify. Moreover, the techniques may also be used to suppress false positive detections. For example, the techniques may increase accurate detection of truncated or partially occluded objects, such as an object that may be near totally occluded by another object, such as a pedestrian that may be occluded from a sensor's view by a vehicle. The techniques discussed herein may detect the pedestrian, even if only the pedestrian's head or head and shoulders are within view. Additionally, the techniques may more accurately identify the portion of sensor data associated with an object, like the head or head and shoulders of the pedestrian. Moreover, the techniques may more accurately detect and/or classify small objects, like debris in a roadway or small animals, such as birds, or objects that a perception component of the vehicle has had no training for or that rarely appears. The techniques may also more accurately determine sensor data associated with static objects, such as signage, fire hydrants, a ground plane and/or driving surface, and/or the like. Discriminating the ground plane from objects and flat shaped objects, particularly in hilly regions, is a difficult task, as incorrectly identifying the ground plane may inadvertently lead to false negatives, which may cause a vehicle to disregard object(s) that should be used as part of the vehicle's planning hardware and/or software determination of operation(s) of the vehicle. Additionally, the techniques may be used to suppress false positives, such as may be caused by a shadow cast by an object, such as a pedestrian (a dynamic false positive) or signage (a static false positive), or static object-shaped dynamic objects (e.g., a pedestrian bending over to tie their shoe that is detected as a static object when the pedestrian should be detected as a dynamic object). Accordingly, the techniques improve the accuracy of a variety of functions of a vehicle, such as sensor data segmentation, false positive detection, object detection, depth determination, localization and/or mapping error determination, and/or the like, while reducing the hardware and/or software latency and/or complexity.

The techniques discussed herein may include a transformer-based machine-learned model that uses cross attention between sensor data and map data to determine one or more outputs that may be used to realize the benefits discussed above. The transformer-based machine-learned model discussed herein may receive sensor data from one or more sensors and map data associated with an environment through which a vehicle is navigating.

The sensor data may include, for example, image data, lidar data, radar data, sonar data, microwave data, and/or the like. For the sake of simplicity, the discussion herein primarily regards image data and lidar data, although the concepts may be extended to other types of sensor data. The techniques may comprise breaking up the sensor data into different portions (patchifying the sensor data) and determining, for a portion of sensor data, a portion of map data that is associated with that portion of sensor data. In an example where the sensor data includes image data or three-dimensional data, such as lidar, radar, or depth camera data, that is projected into a two-dimensional space, an image (or two-dimensional representation) may be patchified into blocks of pixels (e.g., 5×10 pixels, 8×8 pixels, 16×16 pixels, 24×24 pixels, 32×32 pixels, any other size), called image patches. In an additional or alternate example, three (or more)-dimensional data may be patchified into blocks of pixels or other units in an original dimension of the sensor data (e.g., 5×5×5, 8×8×8, 8×16×8, 8×16×16, 16×16×16, any other sized blocks). In some examples, the vehicle may use sensor data and simultaneous localization and mapping (SLAM) techniques to determine a pose (i.e., position and orientation) of the vehicle relative to the environment, which the vehicle may use to identify where the vehicle is in the environment and what portion of map data is associated with the vehicle's current location and pose in the environment. The vehicle may then use this localization to determine a portion of map data that is associated with an image patch.

In an additional or alternate example, the sensor data may include lidar data and the vehicle may have previously detected an object based at least in part on the lidar data. This lidar-based object detection may be used as a lidar patch in its three-dimensional state or may be converted to a two-dimensional representation of the lidar-based object detection and used as a lidar patch. Once the lidar patch has been generated, the vehicle may determine a portion of the map data that is associated with the lidar patch.

The map data may include, for example, geometric data and embeddings associated with the geometric data. The geometric data may identify a location, dimensions, shape, and/or label associated with static features of the environment. In some examples, the location, dimensions, and/or shapes indicated by the geometric data may be three-dimensional. This map data may have previously been generated using a combination of sensor data collected from a vehicle and labelling of such data using machine-learned model(s) and/or human labelling. For example, a label may include a semantic label indicate that a portion of the geometric data is associated with a static object classification, such as a ground plane, roadway/drivable surface, building, signage, or various other static objects (e.g., mailbox, fountain, fence). Additionally or alternatively, the label (e.g., a semantic label and/or numeric or encoded label) may indicate a material type associated with a portion of the environment, such as asphalt, glass, metal, concrete, etc. These material types may have material characteristics associated with them, such as reflectivity, opacity, static coefficient, permeability, occlusion likelihood, and/or the like. The geometric data may be stored and/or indicated in any suitable manner, such as using a polygon representation, a digital wire mesh representation, and/or the like.

In some examples, once an image patch has been generated, a region of the map data associated with the image may be determined based at least in part on the location of the vehicle in the environment and the pose of the vehicle, as determined by SLAM and sensor data. In examples where the map data comprises three-dimensional geometric data, the vehicle may determine a two-dimensional rendering of the geometric data. For example, the geometric data may comprise a mesh defining vertices and faces of shape(s) of the geometry indicated in the geometric data. An embedding may be associated with a vertex that encodes the data discussed herein, although it is further discussed herein that the embedding may be randomly generated at the beginning of training the model discussed herein, and may be refined according to the training. The embedding may by a high-dimensional vector (e.g., tens, hundreds, or thousands of dimensions) indicating characteristics of the environment, as determined according to the training process discussed herein. A face in the geometric data may be associated with two or more vertices, each of which may be associated with different embeddings. These embeddings may be used to render an embedding-based representation of the shape by using differentiable rendering to render a gradient based on the embeddings indicated at the vertices to associate with the face. Once this rendered geometric data has been determined along with the associated embedding gradient(s), the image patch and rendered geometric data may be used by the transformer-based machine-learned model discussed herein.

In an example where a lidar patch is used, the lidar patch may be projected into a two-dimensional representation and the vehicle may determine a two-dimensional rendering of a portion of the map data associated with the lidar patch. In yet another example, the lidar patch may be left in a three-dimensional form and the map data may be rendered in three-dimensions, where the rendering doesn't include the two-dimensional reduction of the geometric data, but may include the differentiable rendering to render a gradient based on the embeddings associated with the geometric data.

Regardless, once a sensor data patch has been generated and the associated rendered map data has been generated (also called a map image patch and embedding herein), the transformer-based machine-learned model may flatten the patches (e.g., convert separate image patches into a series of vectors representing each patch). The transformer-based machine-learned model may use these flattened patches for processing by encoders of the transformer-based machine-learned model to determine respective embeddings for the patches. For example, the transformer-based machine-learned model may include a first encoder to determine a sensor data embedding based at least in part on a flattened sensor data patch (e.g., a vector that represents an image patch, for example) and a second encoder to determine a map embedding based at least in part on a flattened map patch that may comprise a vector representing either two-dimensional or three-dimensional rendering of the geometric data with the graded embeddings associated with respective faces in the geometric data. In some examples, an embedding encoding positional data may be concatenated to a flattened sensor data patch and/or the flattened geometric data patch.

The encoder may comprise one or more linear layers that project a flattened patch (and, in some examples, the positional embedding concatenated to the flattened patch) into an embedding space according to the description herein. In some examples, a linear layer may comprise a normalization layer, a multi-headed attention layer, an addition layer (that adds a an input to a previous component to an output of that component), and/or a multi-layer perceptron. In some examples, the linear layer may be arranged to include a first part comprising a multi-headed attention layer followed by a normalization and/or addition layer that normalizes the output of the multi-headed attention layer and adds the input provided to the multi-headed attention layer to the normalized output of the multi-headed layer. The linear layer may include one or more of these first parts followed by a multi-layer perceptron with a number of heads equal to a number of dimensions of the output vector of the last first part. The multi-layer perceptron may output the final embedding that is associated with the original input data (e.g., an image patch, a lidar patch, a map patch and embedding(s)). See U.S. patent application Ser. No. 18/104,082, filed Jan. 31, 2023, the entirety of which is incorporated herein for all purposes, for additional details.

Once a first embedding has been determined by a first encoder for a sensor data patch and a second embedding has been determined by a second decoder for a map patch, the first embedding and the second embedding may be used to determine an output that may be used by the vehicle to determine control(s) for one or more operations of the vehicle. For example, the output may comprise a semantic segmentation of the sensor data, an object detection associated with an object in the environment, a depth (i.e., a distance from a sensor to a surface and/or to an object detection), false positive status (e.g., an indication that an object detection associated with a sensor data input token is a true positive or a false positive), and/or a localization and/or mapping error.

In some examples, determining this output may comprise determining an attention score based at least in part on the first embedding and the second embedding. In such an example, the sensor data embedding may be used as a query, the map embedding may be used as a key, and the map patch may be used as a value. Determining the attention score may include determining a dot product of the first embedding and the second embedding. This attention score may be used to determine a semantic segmentation of the sensor data by multiplying the attention score with the key, i.e., the map patch. This may be repeated for each sensor patch and map patch. In an additional or alternate example, a threshold may be used to determine that a label associated with the map patch should be associated with the sensor data patch if the attention score meets or exceeds a threshold attention score. In yet another example, the sensor data embedding and the map embedding and/or the attention score may be provided as input to a machine-learned model, such as a multi-layer perceptron or transformer decoder, that determines whether to associate a label associated with the map patch with the sensor data patch, such as via a binary output or likelihood (e.g., posterior probability) that may be softmaxed. The discussion herein describes further permutations of the transformer-based machine-learned model for determining various outputs that may be used by the vehicle to control operation of the vehicle.

In examples, an archetype may be used for map data corresponding to a specific scenario determined using sensor data. For example, an archetype for a certain building type or intersection may be determined via characterizing sensor data and a corresponding archetype from map data selected using the disclosed techniques. This may be useful in instances where map data is unavailable or is stale (e.g., there is a temporary condition in scenario such as construction). Archetypes may be determined through the use of labels (e.g., intersection or road types, types of buildings, locations of features). In some examples, static features of a scene may be parameterized and a distance algorithm used to determine a corresponding map data archetype for use with the scene.

### Example Scenario

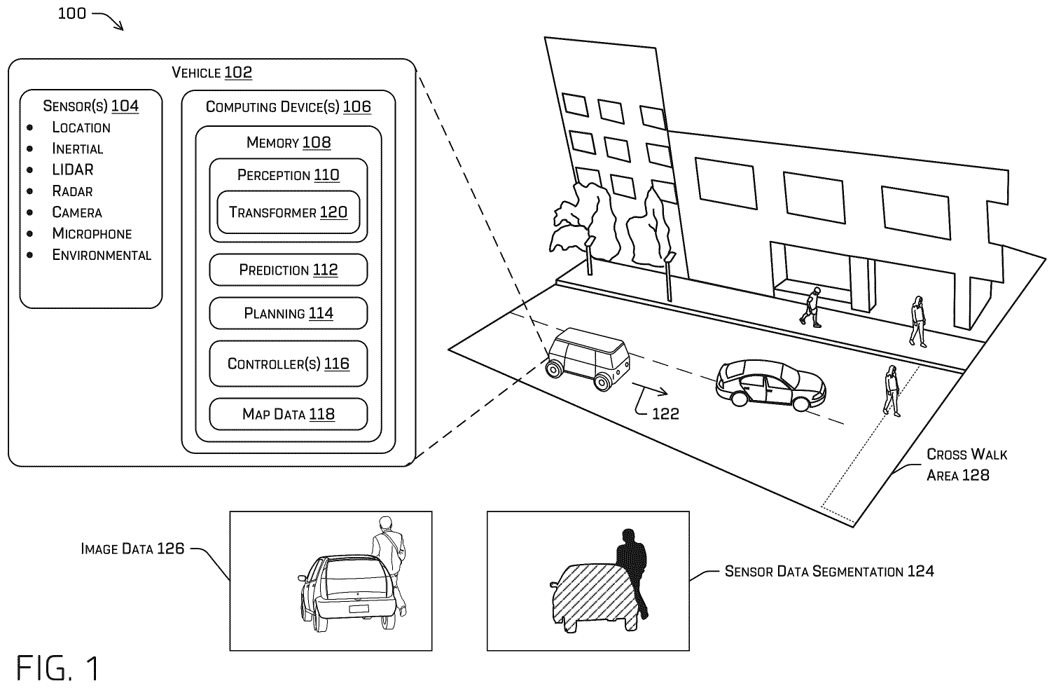

FIG. 1 illustrates an example scenario 100 including a vehicle 102. In some instances, the vehicle 102 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 102 may be a fully or partially autonomous vehicle having any other level or classification. It is contemplated that the techniques discussed herein may apply to more than robotic control, such as for autonomous vehicles. For example, the techniques discussed herein may be applied to mining, manufacturing, augmented reality, etc. Moreover, even though the vehicle 102 is depicted as a land vehicle, vehicle 102 may be a spacecraft, watercraft, and/or the like.

The example scenario 100 may be one that presents particular difficulty for detection capabilities of the vehicle 102, such as partially occluded objects, such as the pedestrians that are partially hidden from the view of sensors of the vehicle 102.

According to the techniques discussed herein, the vehicle 102 may receive sensor data from sensor(s) 104 of the vehicle 102. For example, the sensor(s) 104 may include a location sensor (e.g., a global positioning system (GPS) sensor), an inertia sensor (e.g., an accelerometer sensor, a gyroscope sensor, etc.), a magnetic field sensor (e.g., a compass), a position/velocity/acceleration sensor (e.g., a speedometer, a drive system sensor), odometry data (which may be determined based at least in part on inertial measurements and/or an odometer of the vehicle 102), a depth position sensor (e.g., a lidar sensor, a radar sensor, a sonar sensor, a time of flight (ToF) camera, a depth camera, an ultrasonic and/or sonar sensor), an image sensor (e.g., a visual light camera, infrared camera), an audio sensor (e.g., a microphone), and/or environmental sensor (e.g., a barometer, a hygrometer, etc.).

The sensor(s) 104 may generate sensor data, which may be received by computing device(s) 106 associated with the vehicle 102. However, in other examples, some or all of the sensor(s) 104 and/or computing device(s) 106 may be separate from and/or disposed remotely from the vehicle 102 and data capture, processing, commands, and/or controls may be communicated to/from the vehicle 102 by one or more remote computing devices via wired and/or wireless networks.

Computing device(s) 106 may comprise a memory 108 storing a perception component 110, a prediction component 112, a planning component 114, system controller(s) 116, map data 118, and transformer 120. In some examples, the perception component 110 may include a simultaneous localization and mapping (SLAM) component or, in additional or alternative examples, the SLAM component may be separate and may independently be trained using the seminal model discussed herein.

In general, the perception component 110 may determine what is in the environment surrounding the vehicle 102 and the planning component 114 may determine how to operate the vehicle 102 according to information received from the perception component 110. For example, the planning component 114 may determine trajectory 122 for controlling the vehicle 102 based at least in part on the perception data and/or other information such as, for example, one or more maps (such as a map determined according to the techniques discussed herein, prediction data, localization information (e.g., where the vehicle 102 is in the environment relative to a map and/or features detected by the perception component 110), output determined by the transformer 120, and/or the like. In some examples, the perception component 110 may comprise a pipeline of hardware and/or software, which may include one or more GPU(s), ML model(s), Kalman filter(s), and/or the like.

The trajectory 122 may comprise instructions for controller(s) 116 to actuate drive components of the vehicle 102 to effectuate a steering angle, steering rate, acceleration, and/or the like, which may result in a vehicle position, vehicle velocity, and/or vehicle acceleration. For example, the trajectory 122 may comprise a target heading, target steering angle, target steering rate, target position, target velocity, and/or target acceleration for the controller(s) 116 to track. In some examples, the trajectory 122 may be associated with controls sufficient to control the vehicle 102 over a time horizon (e.g., 5 milliseconds, 10 milliseconds, 100 milliseconds, 200 milliseconds, 0.5 seconds, 1 second, 2 seconds, etc.) or a distance horizon (e.g., 1 meter, 2 meters, 5 meters, 8 meters, 10 meters).

In some examples, the perception component 110 may receive sensor data from the sensor(s) 104 and determine data related to objects in the vicinity of the vehicle 102 (e.g., classifications associated with detected objects, instance segmentation(s), semantic segmentation(s), two and/or three-dimensional bounding boxes, tracks), route data that specifies a destination of the vehicle, global map data that identifies characteristics of roadways (e.g., features detectable in different sensor modalities useful for localizing the autonomous vehicle), a pose of the vehicle (e.g. position and/or orientation in the environment, which may be determined by or in coordination with a localization component), local map data that identifies characteristics detected in proximity to the vehicle (e.g., locations and/or dimensions of buildings, trees, fences, fire hydrants, stop signs, and any other feature detectable in various sensor modalities), etc. In some examples, the transformer 120 discussed herein may determine at least some of this data.

In particular, the perception component 110 and/or transformer 120 may determine, based at least in part on sensor data, an object detection indicating an association of a portion of sensor data with an object in the environment. The object detection may indicate an object classification, sensor data segmentation (e.g., mask, instance segmentation, semantic segmentation) such as the sensor data segmentation 124 depicted in FIG. 1, a region of interest (ROI) identifying a portion of sensor data associated with the object, object classification, and/or a confidence score indicating a likelihood (e.g., posterior probability) that the object classification, ROI, and/or sensor data segmentation is correct/accurate (there may be confidence score generated for each in some examples). For example, the ROI may include a portion of an image or radar data identified by an ML model or ML pipeline of the perception component 110 and/or transformer 120 as being associated with the object, such as using a bounding box, mask, an instance segmentation, and/or a semantic segmentation. The object classifications determined by the perception component 110 and/or transformer 120 may distinguish between different object types such as, for example, a passenger vehicle, a pedestrian, a bicyclist, a delivery truck, a semi-truck, traffic signage, and/or the like. In some examples, object detections may be tracked over time. For example, a track may associate two object detections generated at two different times as being associated with a same object and may comprise a historical, current, and/or predicted object position, orientation, velocity, acceleration, and/or other state (e.g., door state, turning state, intent state such as signaling turn) of that object. The predicted portion of a track may be determined by the prediction component 112 and/or transformer 120, in some examples.

To give a concrete example, the vehicle 102 may receive sensor data including image data (from one or more image sensors), including image data 126, and/or other sensor data associated with the environment, such as lidar data, radar data, ToF data, and/or the like. The perception component may detect and classify objects in the environment. For example, the perception component may detect dynamic objects, such as a cyclist, vehicle, pedestrian, or the like, and/or static objects, such as poles, traffic signage, general signage, a drivable surface, sidewalk, public furniture, building, etc. In the depicted example, the transformer 120 may use the image data 126 and map data 118 to determine the sensor data segmentation 124 and/or other perception data, as discussed further herein. For example, the map data may associate a label, such as “cross walk area” 128 with a portion of the map data, such as a geometric representation of the environment. The transformer 120 may use cross-attention between the image data 126 and the map data 118 to bolster the accuracy of determinations by the transformer 120 discussed herein, like the sensor data segmentation 124. The sensor data segmentation 124 may identify a portion of the sensor data (i.e., image data 126 in this example) associated with different object classifications. In the depicted example, a portion of the image data 126 associated with the object classification “vehicle” is hatched and a portion of the image data 126 associated with the object classification “pedestrian” is solidly filled. In some examples, the perception component 110 and/or transformer 120 may additionally or alternatively determine a confidence score associated with an object detection, such as an object detection associated with the vehicle and/or the pedestrian depicted in the image data 126. Note that, although the depicted example is based on an image, the perception component 110 and/or transformer 120 may generate object detection(s) based on additional or alternate types of sensor data.

In some examples, the perception component 110 may additionally or alternatively determine a likelihood that a portion of the environment is occluded to one or more sensors and/or which particular sensor types of the vehicle. For example, a region may be occluded to a camera but not to radar or, in fog, a region may be occluded to the lidar sensors but not to cameras or radar to the same extent.

The data produced by the perception component 110 and/or transformer 120 may be collectively referred to as perception data. Once the perception component 110 and/or transformer 120 has generated perception data, the perception component 110 and/or transformer 120 may provide the perception data to prediction component 112 and/or the planning component 114. The perception data may additionally or alternatively be stored in association with the sensor data as log data. This log data may be transmitted to a remote computing device (unillustrated in FIG. 1 for clarity) for use as at least part of training data for transformer 120.

In some examples, the prediction component 112 may receive sensor data and/or perception data and may determine a predicted state of dynamic objects in the environment. In some examples, dynamic objects may include objects that move or change states in some way, like traffic lights, moving bridges, train gates, and the like. The prediction component 112 may use such data to a predict a future state, such as a signage state, position, orientation, velocity, acceleration, or the like, which collectively may be described as prediction data.

The planning component 114 may use the perception data received from perception component 110 and/or transformer 120 and/or prediction data received from the prediction component 112, to determine one or more trajectories, control motion of the vehicle 102 to traverse a path or route, and/or otherwise control operation of the vehicle 102, though any such operation may be performed in various other components (e.g., localization may be performed by a localization component, which may be based at least in part on perception data). For example, the planning component 114 may determine a route for the vehicle 102 from a first location to a second location; generate, substantially simultaneously and based at least in part on the perception data and/or simulated perception data (which may further include predictions regarding detected objects in such data), a plurality of potential trajectories for controlling motion of the vehicle 102 in accordance with a receding horizon technique (e.g., 1 micro-second, half a second) to control the vehicle to traverse the route (e.g., in order to avoid any of the detected objects); and select one of the potential trajectories as a trajectory 122 of the vehicle 102 that may be used to generate a drive control signal that may be transmitted to drive components of the vehicle 102. In another example, the planning component 114 may select the trajectory 122 based at least in part on determining the trajectory is associated with a greatest probability based at least in part on an output of the planning task decoder(s) discussed herein. FIG. 1 depicts an example of such a trajectory 122, represented as an arrow indicating a heading, velocity, and/or acceleration, although the trajectory itself may comprise instructions for controller(s) 116, which may, in turn, actuate a drive system of the vehicle 102.

In some examples, the controller(s) 116 may comprise software and/or hardware for actuating drive components of the vehicle 102 sufficient to track the trajectory 122. For example, the controller(s) 116 may comprise one or more proportional-integral-derivative (PID) controllers to control vehicle 102 to track trajectory 122.

### Example System

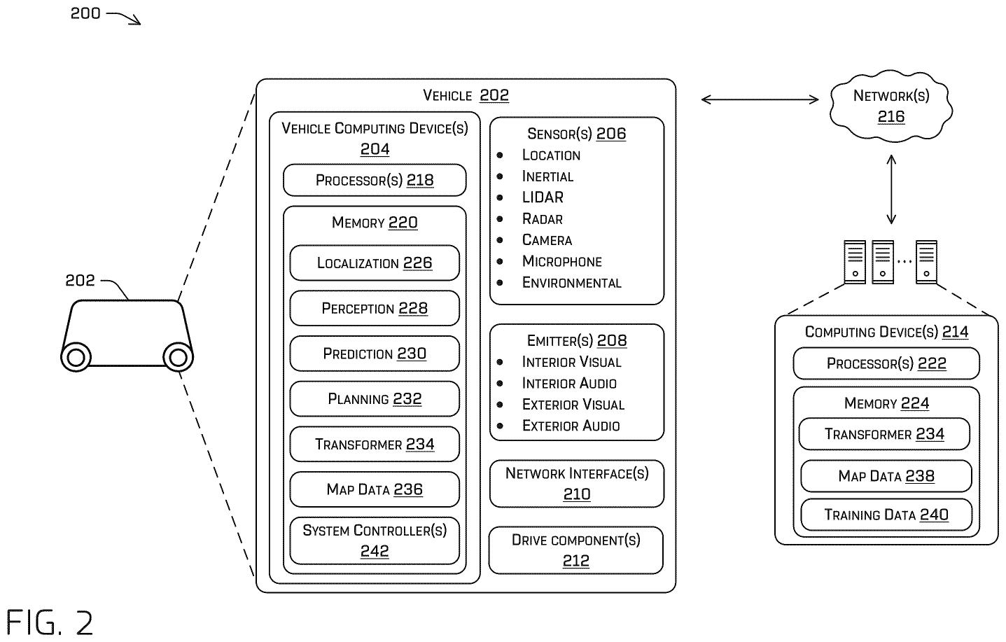

FIG. 2 illustrates a block diagram of an example system 200 that implements the techniques discussed herein. In some instances, the example system 200 may include a vehicle 202, which may represent the vehicle 102 in FIG. 1. In some instances, the vehicle 202 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 202 may be a fully or partially autonomous vehicle having any other level or classification. Moreover, in some instances, the techniques described herein may be usable by non-autonomous vehicles as well.

The vehicle 202 may include a vehicle computing device(s) 204, sensor(s) 206, emitter(s) 208, network interface(s) 210, and/or drive component(s) 212. Vehicle computing device(s) 204 may represent computing device(s) 106 and sensor(s) 206 may represent sensor(s) 104. The system 200 may additionally or alternatively comprise computing device(s) 214.

In some instances, the sensor(s) 206 may represent sensor(s) 104 and may include lidar sensors, radar sensors, ultrasonic transducers, sonar sensors, location sensors (e.g., global positioning system (GPS), compass, etc.), inertial sensors (e.g., inertial measurement units (IMUs), accelerometers, magnetometers, gyroscopes, etc.), image sensors (e.g., red-green-blue (RGB), infrared (IR), intensity, depth, time of flight cameras, etc.), microphones, wheel encoders, environment sensors (e.g., thermometer, hygrometer, light sensors, pressure sensors, etc.), etc. The sensor(s) 206 may include multiple instances of each of these or other types of sensors. For instance, the radar sensors may include individual radar sensors located at the corners, front, back, sides, and/or top of the vehicle 202. As another example, the cameras may include multiple cameras disposed at various locations about the exterior and/or interior of the vehicle 202. The sensor(s) 206 may provide input to the vehicle computing device(s) 204 and/or to computing device(s) 214. The position associated with a simulated sensor, as discussed herein, may correspond with a position and/or point of origination of a field of view of a sensor (e.g., a focal point) relative the vehicle 202 and/or a direction of motion of the vehicle 202.

The vehicle 202 may also include emitter(s) 208 for emitting light and/or sound, as described above. The emitter(s) 208 in this example may include interior audio and visual emitter(s) to communicate with passengers of the vehicle 202. By way of example and not limitation, interior emitter(s) may include speakers, lights, signs, display screens, touch screens, haptic emitter(s) (e.g., vibration and/or force feedback), mechanical actuators (e.g., seatbelt tensioners, seat positioners, headrest positioners, etc.), and the like. The emitter(s) 208 in this example may also include exterior emitter(s). By way of example and not limitation, the exterior emitter(s) in this example include lights to signal a direction of travel or other indicator of vehicle action (e.g., indicator lights, signs, light arrays, etc.), and one or more audio emitter(s) (e.g., speakers, speaker arrays, horns, etc.) to audibly communicate with pedestrians or other nearby vehicles, one or more of which comprising acoustic beam steering technology.

The vehicle 202 may also include network interface(s) 210 that enable communication between the vehicle 202 and one or more other local or remote computing device(s). For instance, the network interface(s) 210 may facilitate communication with other local computing device(s) on the vehicle 202 and/or the drive component(s) 212. Also, the network interface(s) 210 may additionally or alternatively allow the vehicle to communicate with other nearby computing device(s) (e.g., other nearby vehicles, traffic signals, etc.). The network interface(s) 210 may additionally or alternatively enable the vehicle 202 to communicate with computing device(s) 214. In some examples, computing device(s) 214 may comprise one or more nodes of a distributed computing system (e.g., a cloud computing architecture).

The network interface(s) 210 may include physical and/or logical interfaces for connecting the vehicle computing device(s) 204 to another computing device or a network, such as network(s) 216. For example, the network interface(s) 210 may enable Wi-Fi-based communication such as via frequencies defined by the IEEE 802.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s). In some instances, the vehicle computing device(s) 204 and/or the sensor(s) 206 may send sensor data, via the network(s) 216, to the computing device(s) 214 at a particular frequency, after a lapse of a predetermined period of time, in near real-time, etc.

In some instances, the vehicle 202 may include one or more drive components 212. In some instances, the vehicle 202 may have a single drive component 212. In some instances, the drive component(s) 212 may include one or more sensors to detect conditions of the drive component(s) 212 and/or the surroundings of the vehicle 202. By way of example and not limitation, the sensor(s) of the drive component(s) 212 may include one or more wheel encoders (e.g., rotary encoders) to sense rotation of the wheels of the drive components, inertial sensors (e.g., inertial measurement units, accelerometers, gyroscopes, magnetometers, etc.) to measure orientation and acceleration of the drive component, cameras or other image sensors, ultrasonic sensors to acoustically detect objects in the surroundings of the drive component, lidar sensors, radar sensors, etc. Some sensors, such as the wheel encoders may be unique to the drive component(s) 212. In some cases, the sensor(s) on the drive component(s) 212 may overlap or supplement corresponding systems of the vehicle 202 (e.g., sensor(s) 206).

The drive component(s) 212 may include many of the vehicle systems, including a high voltage battery, a motor to propel the vehicle, an inverter to convert direct current from the battery into alternating current for use by other vehicle systems, a steering system including a steering motor and steering rack (which may be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive component(s) 212 may include a drive component controller which may receive and preprocess data from the sensor(s) and to control operation of the various vehicle systems. In some instances, the drive component controller may include one or more processors and memory communicatively coupled with the one or more processors. The memory may store one or more components to perform various functionalities of the drive component(s) 212. Furthermore, the drive component(s) 212 may also include one or more communication connection(s) that enable communication by the respective drive component with one or more other local or remote computing device(s).

The vehicle computing device(s) 204 may include processor(s) 218 and memory 220 communicatively coupled with the one or more processors 218. Memory 220 may represent memory 108. Computing device(s) 214 may also include processor(s) 222, and/or memory 224. The processor(s) 218 and/or 222 may be any suitable processor capable of executing instructions to process data and perform operations as described herein. By way of example and not limitation, the processor(s) 218 and/or 222 may comprise one or more central processing units (CPUs), graphics processing units (GPUs), tensor processing units (TPUs), integrated circuits (e.g., application-specific integrated circuits (ASICs)), gate arrays (e.g., field-programmable gate arrays (FPGAs)), and/or any other device or portion of a device that processes electronic data to transform that electronic data into other electronic data that may be stored in registers and/or memory.

Memory 220 and/or 224 may be examples of non-transitory computer-readable media. The memory 220 and/or 224 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

In some instances, the memory 220 and/or memory 224 may store a localization component 226, perception component 228, prediction component 230, planning component 232, transformer 234, map data 236, training data 238, and/or system controller(s) 240 zero or more portions of any of which may be hardware, such as GPU(s), CPU(s), and/or other processing units. Perception component 228 may represent perception component 110, prediction component 230 may represent prediction component 112, planning component 232 may represent planning component 114, transformer 234 may represent transformer 120, map data 236 may represent map data 118, and/or system controller(s) 240 may represent controller(s) 116.

In at least one example, the localization component 226 may include hardware and/or software to receive data from the sensor(s) 206 to determine a position, velocity, and/or orientation of the vehicle 202 (e.g., one or more of an x-, y-, z-position, roll, pitch, or yaw). For example, the localization component 226 may include and/or request/receive map(s) of an environment, such as map data 236, and can continuously determine a location, velocity, and/or orientation of the autonomous vehicle within the map(s). In some instances, the localization component 226 may utilize SLAM (simultaneous localization and mapping), CLAMS (calibration, localization and mapping, simultaneously), relative SLAM, bundle adjustment, non-linear least squares optimization, and/or the like to receive image data, lidar data, radar data, IMU data, GPS data, wheel encoder data, and the like to accurately determine a location, pose, and/or velocity of the autonomous vehicle. In some examples, the localization component 226 may determine localization and/or mapping data comprising a pose graph (e.g., a sequence of position(s) and/or orientation(s) (i.e., pose(s)) of the vehicle 202 in space and/or time, factors identifying attributes of the relations therebetween, and/or trajectories of the vehicle for accomplishing those pose(s)), pose data, environment map including a detected static object and/or its distance from a pose of the vehicle 202, and/or the like In some instances, the localization component 226 may provide data to various components of the vehicle 202 to determine an initial position of an autonomous vehicle for generating a trajectory and/or for generating map data. In some examples, localization component 226 may provide, to the perception component 228, prediction component 230, and/or transformer 234 a location and/or orientation of the vehicle 202 relative to the environment and/or sensor data associated therewith.

In some instances, perception component 228 may comprise a primary perception system and/or a prediction system implemented in hardware and/or software. In some examples, the perception component 228 may include transformer 234 or the transformer 234 may be a separate component that also determines or uses perception data. The perception component 228 may detect object(s) in in an environment surrounding the vehicle 202 (e.g., identify that an object exists), classify the object(s) (e.g., determine an object type associated with a detected object), segment sensor data and/or other representations of the environment (e.g., identify a portion of the sensor data and/or representation of the environment as being associated with a detected object and/or an object type), determine characteristics associated with an object (e.g., a track identifying current, predicted, and/or previous position, heading, velocity, and/or acceleration associated with an object), and/or the like. The perception component 228 may include a prediction component that predicts actions/states of dynamic components of the environment, such as moving objects, although the prediction component may be separate, as in the illustration. In some examples, the perception component 228 may determine a top-down representation of the environment that encodes the position(s), orientation(s), velocity(ies), acceleration(s), and/or other states of the objects in the environment. For example, the top-down representation may be an image with additional data embedded therein, such as where various pixel values encode the perception data discussed herein. Data determined by the perception component 228 is referred to as perception data.

The prediction component 230 may predict a future state of an object in the environment surrounding the vehicle 202. For example, the future state may indicate a predicted object position, orientation, velocity, acceleration, and/or other state (e.g., door state, turning state, intent state such as signaling turn) of that object. Data determined by the prediction component 230 is referred to as prediction data. In some examples, the prediction component 230 may determine a top-down representation of a predicted future state of the environment. For example, the top-down representation may be an image with additional data embedded therein, such as where various pixel values encode the prediction data discussed herein.

The planning component 232 may receive a location and/or orientation of the vehicle 202 from the localization component 226 and/or perception data from the perception component 228 and may determine instructions for controlling operation of the vehicle 202 based at least in part on any of this data. In some examples, the memory 220 may further store map data, which is undepicted, and this map data may be retrieved by the planning component 232 as part of generating the environment state data discussed herein. In some examples, determining the instructions may comprise determining the instructions based at least in part on a format associated with a system with which the instructions are associated (e.g., first instructions for controlling motion of the autonomous vehicle may be formatted in a first format of messages and/or signals (e.g., analog, digital, pneumatic, kinematic, such as may be generated by system controller(s) of the drive component(s) 212)) that the drive component(s) 212 may parse/cause to be carried out, second instructions for the emitter(s) 208 may be formatted according to a second format associated therewith). In some examples, where the planning component 232 may comprise hardware/software-in-a-loop in a simulation (e.g., for testing and/or training the planning component 232), the planning component 232 may generate instructions which may be used to control a simulated vehicle. These instructions may additionally or alternatively be used to control motion of a real-world version of the vehicle 202, e.g., in instances where the vehicle 202 runs the simulation runs on vehicle during operation.

In some examples, the map data 236 may comprise a two-dimensional or three-dimensional representation of the environment, characteristic(s) associated therewith, and/or embedding(s). A two-dimensional representation may include, for example, a top-down representation of the environment and a three-dimensional representation may comprise position, orientation, and/or geometric data (e.g., a polygon representation, a digital wire mesh representation). Both representations may comprise a label associated with a portion of the top-down representation indicating different characteristic(s) and/or feature(s) of the environment, such as the existence and/or classification of a static object (e.g., signage, mailboxes, plants, poles, buildings, and/or the like); areas of the environment relevant to the vehicle's operations (e.g., crosswalks, drivable surfaces/roadways, turning lanes, controlled intersections, uncontrolled intersections, sidewalks, passenger pickup/drop-off zones, and/or the like); conditional lighting data depending on the time of day/year and/or the existence and location of light sources; object characteristics (e.g., material, refraction coefficient, opacity, friction coefficient, elasticity, malleability); occlusion data indicating portion(s) of the environment that are occluded to one or more sensors of the vehicle 202; and/or the like. The occlusion data may further indicate occlusions to different classes of sensors, such as portion(s) of the environment occluded to visible light cameras but not to radar or lidar, for example. The two-dimensional representation and/or three-dimensional representation may have embeddings associated therewith that encode this data via the learned process discussed herein. For example, for a three-dimensional representation of the environment comprising a mesh, an embedding may be associated with a vertex of the mesh that encodes data associated with a face that may be generated based on one or more vertices associated with the face. For a two-dimensional representation of the environment an edge or other portion of the top-down representation may be associated with an embedding.

The memory 220 and/or 224 may additionally or alternatively store a mapping system, a planning system, a ride management system, simulation/prediction component, etc.

As described herein, the localization component 226, the perception component 228, the prediction component 230, the planning component 232, transformer 234, and/or other components of the system 200 may comprise one or more ML models. For example, localization component 226, the perception component 228, the prediction component 230, and/or the planning component 232 may each comprise different ML model pipelines. In some examples, an ML model may comprise a neural network. An exemplary neural network is a biologically inspired algorithm which passes input data through a series of connected layers to produce an output. Each layer in a neural network can also comprise another neural network, or can comprise any number of layers (whether convolutional or not). As can be understood in the context of this disclosure, a neural network can utilize machine-learning, which can refer to a broad class of such algorithms in which an output is generated based on learned parameters.

The transformer 234 may comprise a transformer comprising encoder(s) and/or decoder(s) trained to generate the perception data discussed herein. For example, the encoder(s) and/or decoder(s) may have an architecture similar to visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, RoBERTa, XLNet, GPT, GPT-2, GPT-3, GPT-4, or the like. Additionally or alternatively, the transformer 234 may comprise one or more neural network architectures, such as a convolutional neural network (CNN), multi-layer perceptron (MLP), VQGAN, which combines an autoregressive transformer with convolutional network components (or any other generative adversarial network (GAN), CLIP (which can be used to enhance sensor data learning with natural language supervision (such as by using the text data discussed herein as input)), or VQGAN and CLIP used together. The transformer 234 may comprise the transformer-based machine-learned model architecture and processes discussed in more detail herein.

In some examples, the transformer 234 may be trained at computing device(s) 214 based at least in part on map data 236 (which may be the same or different than the map data 236 stored in memory 220 on the vehicle 202) and/or training data 238. Training data 238 may include task-specific training data, such as sensor data and associated ground truth perception data taken from log data or synthetically generated; sensor data and/or perception data and associated ground truth prediction data taken from log data or synthetically generated; sensor data and associated ground truth localization data taken from log data or synthetically generated; and/or sensor data, perception data, prediction data, and/or localization data and associated ground truth prediction data taken from log data or synthetically generated. For example, the training data may comprise input data, such as sensor data, and ground truth data associated with the task for which the transformer 234 is being trained, such as sensor data segmentation, object detection, vehicle pose, depth, and/or the like. In some examples, training the transformer 234 may be self-supervised or semi-self supervised using the ground truth data discussed above. For example, the ground truth data may include perception data determined by the perception component 228 of the vehicle, for a first stage of training the transformer 234. Further refined ground truth data determined by a larger, more complex MIL, model and/or human labelling may be used for a second stage of training the transformer 234 that may further refine the training of the transformer 234, although in one example, just this complex MIL, model and/or human labelling may be used instead of using two stages. In an additional or alternate example, a larger and more complex model than could be used on vehicle 202 can be used to generate the ground truth data and/or human labelling may additionally or alternatively be used to generate the ground truth data, such as by modifying ground truth data generated from log data or a powerful offline model to adjust the ground truth data for errors. In some examples, once the transformer 234 has been trained at computing device(s) 214, it may be transmitted to vehicle 202 for storage in memory 220 and may cause processor(s) 218 to cause the operations discussed herein.

Although discussed in the context of neural networks, any type of machine-learning can be used consistent with this disclosure. For example, machine-learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet-50, ResNet-101, VGG, DenseNet, PointNet, Xception, ConvNeXt, and the like; visual transformer(s) (ViT(s)), such as a bidirectional encoder from image transformers (BEiT), visual bidirectional encoder from transformers (VisualBERT), image generative pre-trained transformer (Image GPT), data-efficient image transformers (DeiT), deeper vision transformer (DeepViT), convolutional vision transformer (CvT), detection transformer (DETR), Miti-DETR, or the like; and/or general or natural language processing transformers, such as BERT, GPT, GPT-2, GPT-3, or the like. In some examples, the ML model discussed herein may comprise PointPillars, SECOND, top-down feature layers (e.g., see U.S. patent application Ser. No. 15/963,833, which is incorporated by reference in its entirety herein for all purposes), and/or VoxelNet. Architecture latency optimizations may include MobilenetV2, Shufflenet, Channelnet, Peleenet, and/or the like. The ML model may comprise a residual block such as Pixor, in some examples.

Memory 220 may additionally or alternatively store one or more system controller(s) (which may be a portion of the drive component(s)), which may be configured to control steering, propulsion, braking, safety, emitters, communication, and other systems of the vehicle 202. These system controller(s) may communicate with and/or control corresponding systems of the drive component(s) 212 and/or other components of the vehicle 202. For example, the planning component 232 may generate instructions based at least in part on perception data generated by the perception component 228 and/or simulated perception data and transmit the instructions to the system controller(s), which may control operation of the vehicle 202 based at least in part on the instructions.

It should be noted that while FIG. 2 is illustrated as a distributed system, in alternative examples, components of the vehicle 202 may be associated with the computing device(s) 214 and/or components of the computing device(s) 214 may be associated with the vehicle 202. That is, the vehicle 202 may perform one or more of the functions associated with the computing device(s) 214, and vice versa.

### Example Encoder Portion of the Transformer-Based Machine-Learned Model (Image-Based Example)

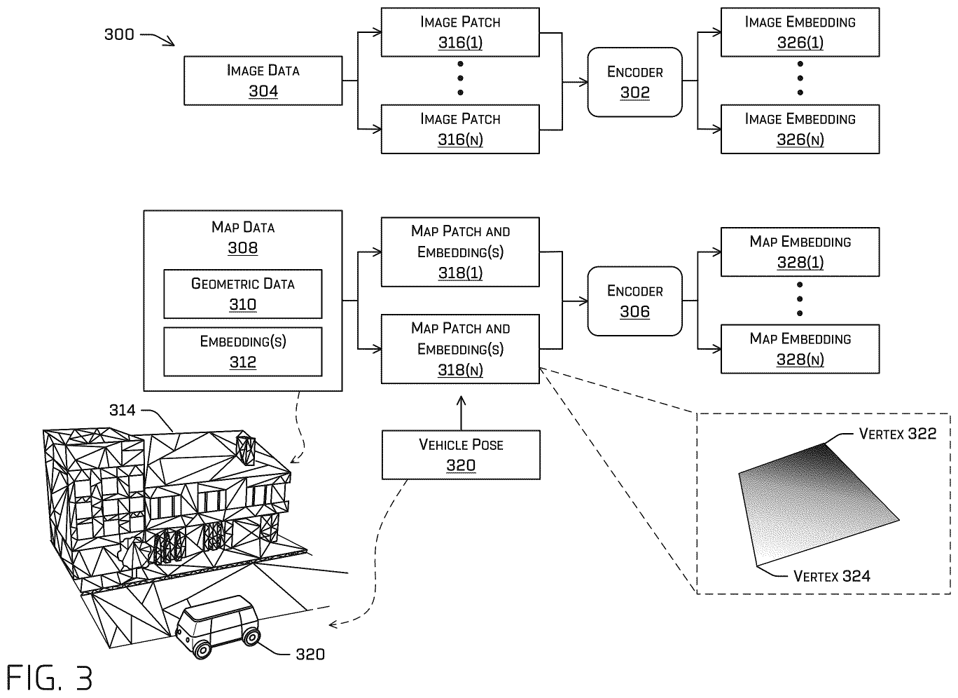

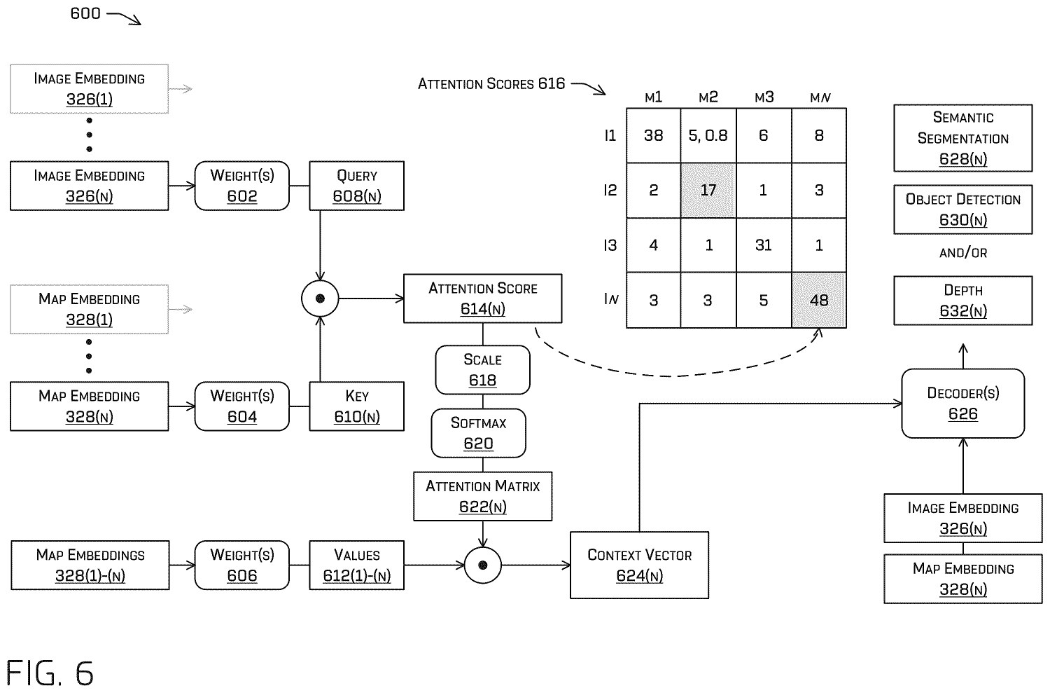

FIG. 3 illustrates a block diagram of part of an example architecture 300 of part of the transformer-based machine-learned model discussed herein with encoders that generate embeddings used for sensor-map cross-attention to generate perception data. A second part of the transformer-based machine-learned model architecture is discussed in FIG. 6 that may, with example architecture 300, complete the transformer-based machine-learned model discussed herein by including decoder(s) and/or other ML model(s).

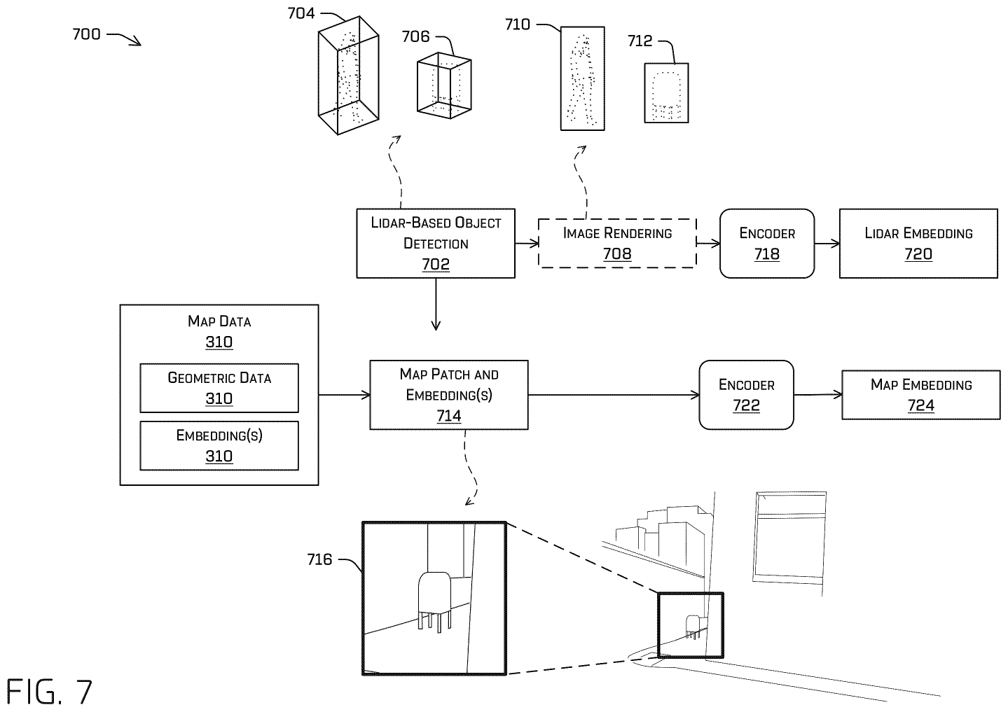

The example architecture 300 may comprise an encoder associated with a sensor modality for which perception data may be generated, although FIGS. 3 and 7 depicted just one sensor modality at a time. For example, example architecture 300 may comprise encoder 302 for processing image data 304, which may comprise visual light, infrared, or other sensor data from a camera. In an additional or alternate example, the image data 304 may be a top-down representation of the environment determined by the perception component. The transformer-based machine-learned model may include additional encoder(s) for handling different sensor modality(ies)' data, such as a lidar data-based object detection, as depicted in FIG. 7. For example, the sensor data may comprise any of the sensor data discussed herein, such as location data, an inertial data, magnetic field data, odometry data, depth data, image data, audio data, and/or environmental data.

The example architecture 300 may further comprise an encoder 306 for processing map data 308. The map data 308 may comprise geometric data 310 and embedding(s) 312. The geometric data 310 may include a data structure identifying features of the environment, such as a polygon representation, mesh representation, wireframe representation, or the like of an environment. For example, FIG. 3 includes an example of geometric data 310 that includes mesh 314. Mesh 314 may comprise vertices and faces therebetween that define surfaces in the environment. In an additional or alternate example, the map data 308 may include simpler canonic geometric shapes, such as a variety of archetypical building shapes, scenes, roadways, intersection, signage shapes, bench or other static object shapes, roadway shapes, sidewalk shapes, and/or the like. For example, a variety of different canonic signage shapes may be used to represent different signage.

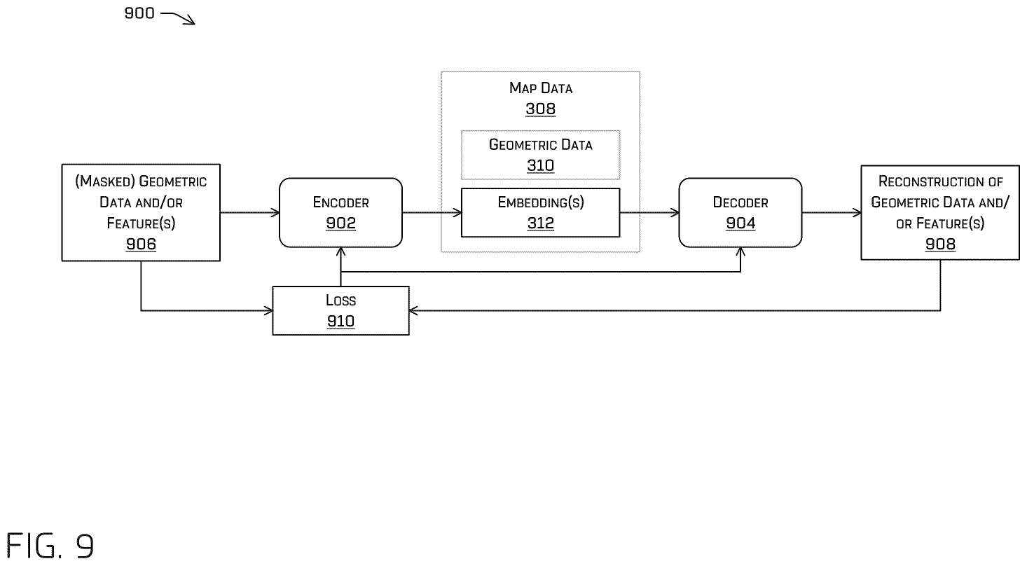

Regardless of the type of data structure used as the geometric data 310, an embedding may be associated with a portion of the geometric data. For example, an embedding may be associated with a vertex in a mesh, an edge of a wireframe, a polygon, or the like. The embedding may be learned, according to the discussion of FIG. 9. In some examples, the embedding may encoder features of the environment, such as data that may be relevant to a vehicle's operations (e.g., crosswalk region, stop line, yield region, junction, controlled/uncontrolled intersection), signage classification (e.g., stoplight, stop sign, speed sign, yield sign), material type, characteristic(s) (e.g., reflectivity, opacity, static coefficient, permeability, occlusion likelihood), lighting or shadow existence/strength/conditions (e.g., time of day that a shadow or light exists and/or a shape thereof associated with a time of day/year), etc. In some examples, an encoder may be used to project any of this data into an embedding space as the embedding to be associated with the portion of geometric data with which this data is associated. The embedding may be a high-dimensional vector or tensor that represents this data in the embedding space where distance in the embedding space represents different combinations of the environment features.

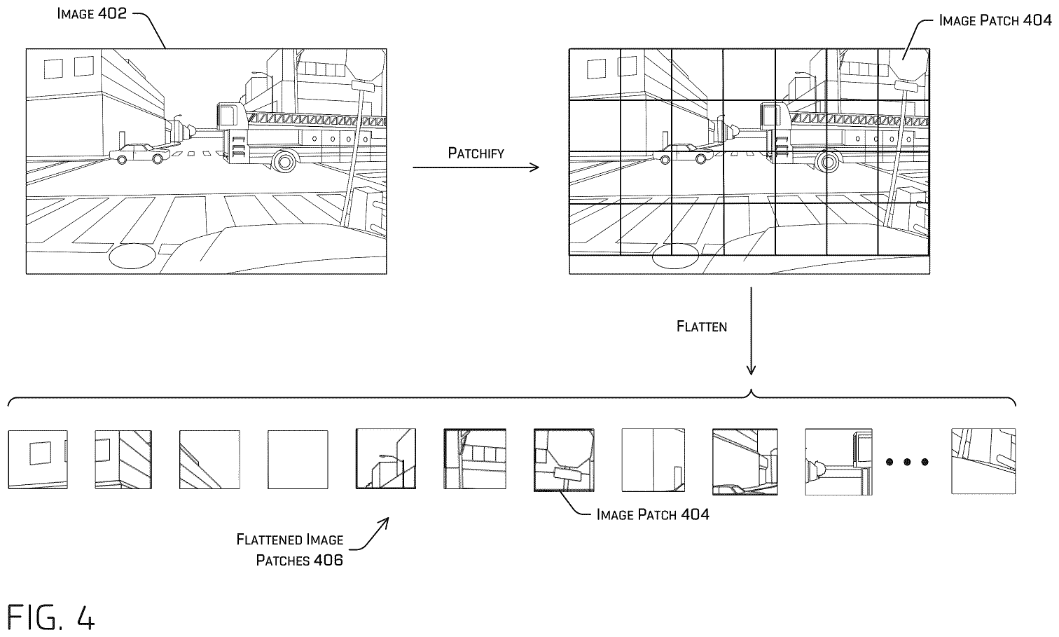

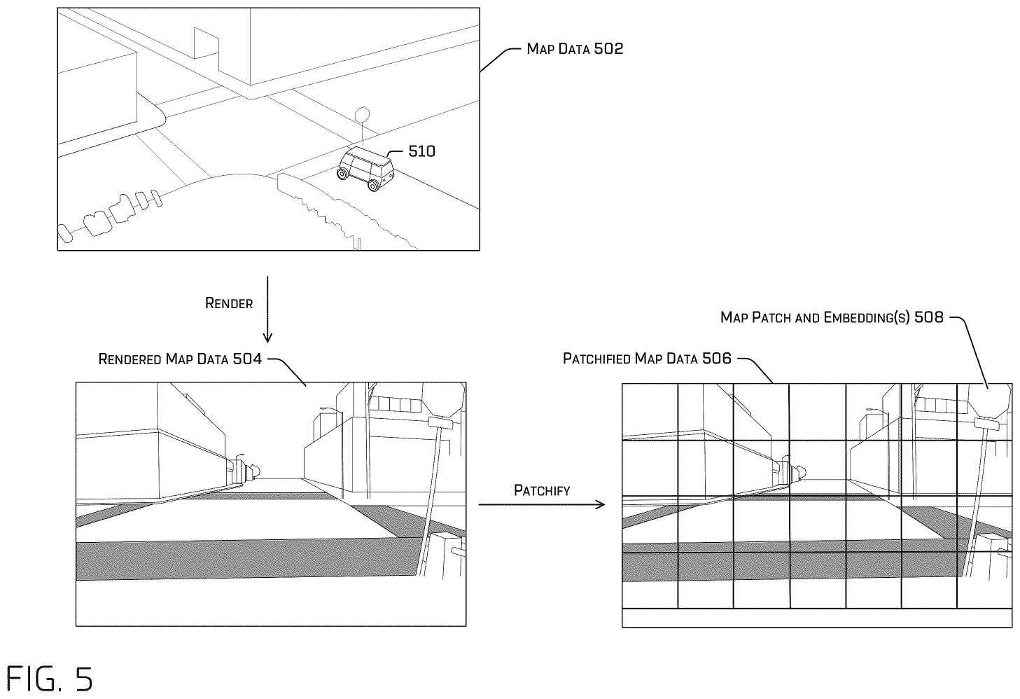

As is discussed in further detail in association with FIGS. 4 and 5, the image data 304 and map data 308 may be patchified into respective patches (i.e., patchified). In some examples, the sensor data, i.e., image data 304 in the depicted example, may be patchified into patches, i.e., image patches 316(1)-(n) in the depicted example, where n is a positive integer. Patchifying sensor data is discussed in more detail in FIG. 4, but may include breaking the image data up into groups of pixels, such as 8×8, 6×8, 16×16, 16×8, 8×16, 20×16, 20×20, 16×24, 32×32, or any other number of blocks of pixels, as an example, although any other portions may be used. The size of the image and the size of the patches may determine n.

The disclosed techniques can be used to patchify fused sensor data (e.g., of multiple modalities) or unfused sensor data. As disclosed herein, sensor data and/or map can be patchified to patches in a variety of ways. For example, data may be flattened as disclosed herein. In some examples, volumetric data may be processed using three-dimensional patches from map or sensor data. In some examples, data from perspective-based sensors (e.g., imaging cameras, infrared sensors, etc.) can be patchified into two-dimensional patches which can be tokenized and combined with three-dimensional patches in a variety of ways (e.g, concatenated, hashed, etc.). In examples, a post of vehicle and/or a sensor of a vehicle can be used to determine a portion of a perspective view that corresponds to a portion of map data. This can include determining a distance to an object or area within a perspective view and/or transforming a perspective view image to view corresponding to map data (e.g., a top-down view) or vice versa.

The map data may be discretized (patchified) into a same number of patches as the image patches 316. In some examples, patchifying the map data may first include rendering a view of the map data into a same dimension as the sensor data (e.g., two-dimensions for two-dimensional image data, three-dimensions for lidar data, two-dimensions for flattened lidar data) that is based at least in part on a vehicle pose 320 of the vehicle. For example, the pose may be used to determine a position and orientation of the vehicle in the environment and a known location and orientation (relative to the vehicle pose 32) of the sensor that generated the sensor data may be used to render a view of the geometric data 310.

In some examples, rendering the view of the geometric data 310 may further comprise differentiable rendering to determine a graded representation of the environment using the embedding(s) 312. For example, a first embedding may be associated with a first vertex 322 of the geometric data 310 and a second embedding may be associated with a second vertex 324 of the geometric data 310. Differentiable rendering (or any other suitable rendering technique) may be used to grade a face associated with the first vertex 322 and the second vertex 324. To give a simple example, embeddings may be thought of replacing rendering RGB color for the face in a normal rendering process. In other words, the resultant rendering of the map data can have shades/values associated therewith that are a result of determining a gradient between one or more embeddings associated with the geometric data. A shade/value may thereby be associated with an embedding in the embedding space that is at or in between one or more embeddings, for example. Note, too, that the depicted example is simplified to show a gradient between vertex 322 and vertex 324, even though two additional vertices may also be associated with the face depicted in FIG. 3. A face may have any number of vertices associated therewith and the gradient may, simply, define a blending of the embeddings associated with the different vertices of the face.

Once a view of the map data has been generated with gradients rendered based on the embedding(s) 312, the map data may be patchified into patches of a same size and number as the sensor data patches, such as image patches 316. Since these patches include both geometric data and the gradients rendered as discussed above, the n-th one of these patches is referred to herein simply as a map patch and embedding(s) 318(n) or, more simply map patches, which may include a depiction/view of a portion of the rendered view of the map data along with the embedding(s) of the respective gradient(s) determined in association with the geometric data in the view. Additionally, the map patches may correspond with the image patches, such that map patch and embedding(s) 318(1) is associated with a same or similar area of the environment as captures in image patch 316(1), and so on. A difference between the image patch and the map patch may be due to error in the vehicle pose 320, hence describing an associated image patch and map patch as being the same or similar area.

In some examples, position data may be associated with the image patches 316 and/or the map patches 318. For example, a first number identifying a position in the patchified image data and map data may be concatenated to image patch 316(1) and map patch 318(1). In some examples, the image patches 316 and/or the map patches 318 may be flattened before use by the encoder 302 and/or encoder 306 by converting the image patches 316 and/or the map patches 318 to a series of vectors representing the patches or a series of image patches and/or map patches that are no longer organized as an image, as discussed and depicted in FIG. 4.

In some examples, the encoder 302 may determine an embedding for up to all of the image patches 316. For example, the encoder 302 may determine image embedding 326(1) based at least in part on image patch 316(1) and any number of the image patches up to an n-th image embedding 326(n) based at least in part on image patch 316(n). In some examples, the encoder 302 may determine the image embedding 326(1) based at least in part on the other image patches, i.e., image patches 316(2)-(n).

Similarly, encoder 306 may determine map embeddings 328 based at least in part on map patch and embedding(s) 318. For example, encoder 306 may determine a first map embedding 328(1) based at least in part on a first map patch and embedding(s) 318(1) up to an n-th map embedding 328(n) based at least in part on n-th map patch and embedding(s) 318(n). In some examples, the encoder 306 may determine the map embedding 328(1) based at least in part on the other map patches, i.e., map patches 318(2)-(n).

In some examples, encoder 302 and/or encoder 306 may comprise one or more linear projection layers. In some examples, although encoder 302 and encoder 306 are depicted as separate encoders, in some examples, the encoder 302 and encoder 306 may comprise different heads of a same encoder. In such an example, the encoder may use cross-attention by employing an image patch as a query, the map patch as a key, and the map patch and/or embedding(s) as a value, as discussed in more detail in association with FIG. 6. Regardless, the encoder 302 and/or encoder 306 may comprise a first unit comprising a multi-headed attention layer (which may receive the sensor patches for encoder 302, the map patches for encoder 306, or both for a cross-attention encoder), a first normalization layer that normalizes the output from the multi-headed attention layer and adds or concatenates the original inputs to the normalized output as a first intermediate output, a feedforward network (e.g., an MLP) that determines a second intermediate output based at least in part on the first intermediate output, and a second normalization layer that normalizes the second intermediate output and adds or concatenates the first intermediate output to the normalized feed forward network's output. This last output of the second normalization layer with the second intermediate output added thereto may include the image embeddings 326 (for encoder 302) and/or map embeddings 328 (for encoder 306). In some examples, the first unit or any portion thereof may be repeated, such as by including an additional multi-headed attention layer and normalization/addition layer.

### Example Patchification and Flattening

FIG. 4 illustrates an example of patchifying an image 402 into image patches and flattening the image patches into flattened image patches for use by the encoder discussed above. In the depicted example, image 402 may be patchified into 14 different patches, one of which may be image patch 404. These image patches may be flattened to form flattened image patches 406 by disassociating the image patches from the original image structure and converting the image 402 to a series of image patches or a series of vectors, where a first vector may represent a first image patch and the data indicated thereby.

FIG. 5 illustrates an example of rendering a two-dimensional representation of map data from map data 502 and patchifying the rendered map data 504 into patchified map data 506 that includes map patches and embeddings, such as map patch and embedding(s) 508. The map data 502 may be retrieved from a memory and/or generated based at least in part on SLAM techniques based at least in part on sensor data received by the vehicle. In some examples, the portion of map data 502 retrieved or generated may be based at least in part on a current pose 510 of the vehicle in the environment. The depicted map data 502 indicates geometric features of an environment associated with the environment. This environment is the same environment indicated by the image 402 and, notably, includes indications of static features in the environment.

Based on the pose 510 of the vehicle in the environment and a known pose of a sensor that generated image 402 relative to the pose of the vehicle, the techniques discussed herein may include rendering a view of the map data 502 based on the pose of the vehicle as rendered map data 504. Notably, the depiction of the rendered map data 504 includes gray-shaded crosswalks, which may be an example depiction of rendering embeddings in association with roadway geometric data based on the embeddings associated with those portions of the geometric data in map data 502. Although the crosswalk sections are depicted as a solid gray and only crosswalk portions of the environment are indicated, it is understood that in practice, the rendering may be a gradient based on the embeddings associated with the map data 502 and may include far more gradients than those shown in FIG. 5. Since the embeddings may be learned, they may not always be easily identifiable by a human or identifiable at all by a human since they may not map to the geometric data in a manner that a human could easily interpret or be able to interpret at all. In other words, the resultant gradients may not be as need or uniform as the shaded crosswalks that are depicted.

Once the rendered map data 504 has been determined, the rendered map data 504 may be patchified, as patchified map data 506, in a manner that corresponds with the manner in which the image 402 was patchified, so that a patchified portion of the rendered map data 506 will be associated with a patchified portion of the image 402. See, for example, that the size and number of the patchified portions are the same between patchified map data 506 and the patchified image in FIG. 4. For example, note that map patch and embedding(s) 508 and image patch 404 are associated with a same portion of the environment and may have the same dimensions. In some examples, patchified map data 506 may be flattened in the same manner in which the patchified image is flattened into flattened image patches 406. This has not been depicted for the sake of room and since the process may be the same.

### Example Decoder Portion of the Transformer-Based Machine-Learned Model

FIG. 6 illustrates a block diagram of an example architecture 600 of a decoder portion of the example transformer-based machine-learned model discussed herein. In some examples, the transformer-based machine-learned model may comprise example architecture 300, example architecture 600, example architecture 700, and/or example architecture 800. This decoder portion may be used to determine attention score(s) and use the attention score(s), ML model head(s), and/or decoder(s) to determine various outputs that a vehicle can use to control operations of the vehicle. For example, these outputs may be at least part of perception data used by the vehicle to control operations of the vehicle. Note that the discussion of FIG. 6 follows the processing of a single image embedding, image embedding 326(n) in a single-headed attention network, but that a similar process may be followed for other sensor modalities and/or that the example architecture may be a multi-headed attention network that may process the other image embeddings and map embeddings (grayed out in FIG. 6).

The example architecture 600 may comprise weight matrices (i.e., weight(s) 602, weight(s) 604, and weight(s) 606) for determining a query, key, and value based at least in part on the image embedding 326(n), map embedding 328(n), and map patch and embedding(s) 318(n). The query, key, and value may each comprise different vectors or tensors generated from the respective embeddings as discussed below. Each of the weight matrices may be trained using the loss determined as discussed herein, to reduce the loss by altering one or more weights of any one or more of these weight matrices. For example, the weight(s) 602 may determine query 608(n) by multiplying the image embedding 326(n) by the weight(s) 602. The query 608 may comprise a vector or tensor. Similarly, the weight(s) 604 may determine key 610(n) by multiplying the map embedding 328(n) by the weight(s) 604 and the weight(s) 606 may determine values 612(1)-(n) by multiplying the map embedding 328(n) by the weight(s) 606. The key 610(n) and value 612(n) may each be a vector. The values 612(1)-(n) may be values generated for one of the map embeddings 328(n) or up to all of the map embedding(s) 328(1)-(n).

The example architecture 600 may determine an attention score 614(n) (i.e., a cross-attention score) based at least in part on determining a dot product of query 608(n) with key 610(n). In some examples, the attention score 614(n) may be determined by determining a dot product of query 608(n) with a transpose of key 610(n). The attention score may be any number before being scaled at 618 and/or softmaxed at 620. For example, the attention scores 616 of image embeddings 326(1), 326(2), 326(3), and 326(n) and mapping embeddings 328(1), 328(2), 328(3), and 328(n) are depicted in the grid depicted in FIG. 6. Attention score 614(n) is depicted in a grayed out square as the value 48. Although positive integers are depicted, attention scores could be negative. Note that attention scores may be calculated between non-associated image embeddings and map embeddings, such as image embedding 326(1) and map embedding 328(3), which has an attention score of 5.

To give some explanation for the potential meaning behind the depicted attention scores 616, attention score 614(n) may, by its relatively high value, 48, mean that the key 610(n) strongly correlates with the query 608(n). This may indicate that the image patch and map patch are highly correlated, i.e., the image data and the rendered may data appear to be very similar. Whereas, the attention score for image embedding 326(2) and map embedding 328(2), depicted near the upper left of the grid (and grayed) as the value 17, this value is relatively low, which may indicate that the rendered map data associated with embedding 328(2) and the image patch associated with image embedding 326(2) are not very correlated, which may indicate that a dynamic object exists at this location since there is an apparent difference between the map data and the image data, as indicated by the lower attention score.

The attention score 614(n) may then be scaled at 618 by dividing the attention score 614(n) by the square root of the dimension of the key 610(n). This result may be softmaxed at 620 to convert the result to a number between 0 and 1, as the attention matrix 622(n). Determining a dot product of the attention matrix 622(n) with values 612 (1)-(n) may be used to determine a context vector 624(n). The context vector 624(n) may indicate the contextual information associated with image embedding 326(n) and may be provided to one or more decoders, decoder(s) 626, which may determine the outputs discussed herein. In some examples, multiple context vectors 624 associated with the image embeddings 326 may be provided as input to the decoder(s) 626 to determine this output. There may be one decoder per output determined or, in another example, a decoder may include multiple output heads, different heads of which may be associated with a different output.

In some examples, one of the decoder(s) 626 may include a first multi-headed self-attention layer, a subsequent add and normalization layer, a second multi-headed self-attention layer, another add and normalization layer, a feedforward network (e.g., a MLP), and another add and normalization layer to determine the outputs discussed herein. In an additional or alternate example, one of the decoder(s) 626 may include just a MLP. An output determined by one of the decoder(s) 626 may include a semantic segmentation 628(n), object detection 630(n), and/or depth 632(n). In some examples, the decoder(s) 626 may additionally or alternatively receive the image embedding 326(n) and/or map embedding 328(n) as input as part of determining any of these outputs. In some examples, the decoder(s) may use the context vector 624(n) alone, the context vector 624(n) and image embedding 326(n) and/or map embedding 328(n), or image embedding 326(n) and map embedding 328(n) to determine any of the outputs. In some examples, the decoder(s) 626 may use an image embedding 326(n) and the map embedding(s) 328 associated with the nearest m number of map patches to the image patch associated with the image embedding 326(n), where m is a positive integer and may include at least the map embedding 328(n) associated with the image embedding 326(n) and m−1 other embeddings associated with the next m−1 nearest map patches.

In some examples, the semantic segmentation 628(n) may indicate that a label from the map data 308 is associated with the image patch 316(n) from which the image embedding 326(n) was generated. Which label is associated with the image patch 316(n) may depend on the context vector 624(n) (e.g., by determining a maximum value of the context vector and the embedding or of the map data with which the maximum value is associated) and/or output of the decoder(n) 626. This process may be repeated for any of the other image embeddings 326 to determine a semantic segmentation associated with the original image data 304. In an additional or alternate example, an instance segmentation may be determined according to similar methods, although an instance segmentation may merely identify discrete objects and/or regions rather than additionally associating a label with such discrete objects and/or regions. In some examples, the semantic segmentation 628(n) may additionally or alternatively indicate a region of interest (e.g., a bounding shape) associated with the sensor data and/or a sensor data segmentation associated with the sensor data (e.g., a mask, instance segmentation, semantic segmentation, or the like).

In some examples, the object detection 630(n) may include an indication that an object is depicted within the image patch 316(n) and, in some examples, may further comprise a position, orientation, velocity, acceleration, state, and/or classification of an object. In some examples, the decoder(s) 626 may additionally or alternatively output a confidence score (e.g., a probability, a posterior probability/likelihood) in association with the object detection 630(n). In some examples, this object detection may be used in combination with depth 632(n) to determine an estimated three-dimensional ROI associated with the detected object. The object detection may, in some cases, be associated with an object for which the perception component has had little or no training and that could be misclassified or failed to be detected. By determining the object detection 632, the architecture discussed herein may detect such objects. In some examples, the depth 632(n) may indicate a distance from the sensor that generated the image data 304 to a surface, e.g., of a dynamic object or a static object.

Any of these outputs may be provided as part of the perception data to one or more downstream components of the vehicle. For example, the outputs may be provided to a planning component of the vehicle as part of perception data for use by the planning component to determine a trajectory for controlling motion of the vehicle and/or other operations of the vehicle, such as whether to open or close an aperture, cause an emission (e.g., lights, turn signal, horn, speaker), transmit a request for teleoperations assistance, or the like.

### Example Additional or Alternate Transformer-Based Machine-Learned Model Components (Lidar-Based Example)

FIG. 7 illustrates a block diagram of part of an example architecture 700 of part of the transformer-based machine-learned model discussed herein with encoders that generate embeddings used for sensor-map cross-attention to generate perception data. A second part of the transformer-based machine-learned model architecture is discussed in FIG. 6 that may, with example architecture 700, complete the transformer-based machine-learned model discussed herein by including decoder(s) and/or other ML model(s). The encoder(s) described in FIG. 7 may use lidar-based data to determine a false-positive status for a lidar-based object detection, although it is understood that the concepts may be applied to other sensor modalities. Moreover, lidar may be used in addition to or instead of image data in a similar configuration to those discussed regarding FIGS. 3 and 6.

The example architecture may receive a lidar-based object detection 702, which, for the sake of an example, may comprise a pedestrian detection 704 or a mailbox detection 706. The false positive status determination discussed herein may particularly apply to determining whether an object detection correctly identifies a dynamic object or static object. The pedestrian detection 704 may be an example of a true positive dynamic object detection and the mailbox detection 706 may be an example of a false positive dynamic object detection. Pedestrian detection 704 may be an example of a false positive static object detection and the mailbox detection 706 may be an example of a true positive static object detection. In some examples, the three-dimensional data itself may be used or a mesh or wireframe representation of the lidar data. In an additional or alternate example, the example architecture 700 may render a two-dimensional version of the detection at 708, resulting in a sensor-view perspective, such as the pedestrian image 710 or the mailbox image 712, or a top-down perspective. In additional or alternate example, the sensor data used herein may comprise sensor data from two or more sensor modalities, such as a point cloud determined based at least in part on lidar data, radar data, image-depth data, and/or the like. Additionally or alternatively, the pedestrian image 710 and/or the lidar-based object detection 702 may be flattened (see FIG. 4 discussion of flattening).

The example architecture 700 may determine a portion of the map data 308 that is associated with the lidar-based object detection 702 based at least in part on a vehicle pose within the environment. In some examples, the example architecture may determine one or more map patches and embedding(s) associated therewith, similar to the process discuss above regarding map patches 318, which may include rendering embedding gradient(s) associated with the surfaces of the geometric data 310 as part of the map patch and embedding(s) 714 (simply referred to as the map patch 714 herein). If the lidar-based object detection 702 is left in a three-dimensional form, the map patch 714 may also be rendered in three-dimensions. For example, this may include determining a three-dimensional map patch by rendering a three-dimensional representation of the scene (including rendering the embedding gradients for the scene) and patchifying the three-dimensional representation into disparate cubes, cuboids, or any other discrete portions. Although if an image of the lidar detection is rendered, the map patch 714 may also be rendered as an image. For example, FIG. 7 depicts a map patch 716 depicting a mailbox, which may be one patch of a larger image. Note that the depiction of map patch 716 (and the larger image surrounding the mailbox) do not include a rendering of the embeddings due to the complexity of such a rendering. The map patch 714 and lidar patch (704 or 706, or 710 or 712) may be patchified using a same or similar method so that the resulting patches correspond to a same portion of the environment. One may be a scaled version of the other or they may share a same scale. In some examples, the map patch 714 may be flattened (see FIG. 4 discussion of flattening).

Encoder 718 may determine a lidar embedding 720 based at least in part on the rendered lidar image generated at 708 or lidar-based object detection 702, e.g., by projecting this data into an embedding space. Encoder 722 may determine map embedding 724 based at least in part on the map patch and embedding(s) 714, e.g., by projecting this data into a same or different embedding space. The encoder 718 and encoder 72 may have a similar configuration to encoder 302 and/or encoder 306 and, in some examples, may be separate encoders or may be part of a same encoder.

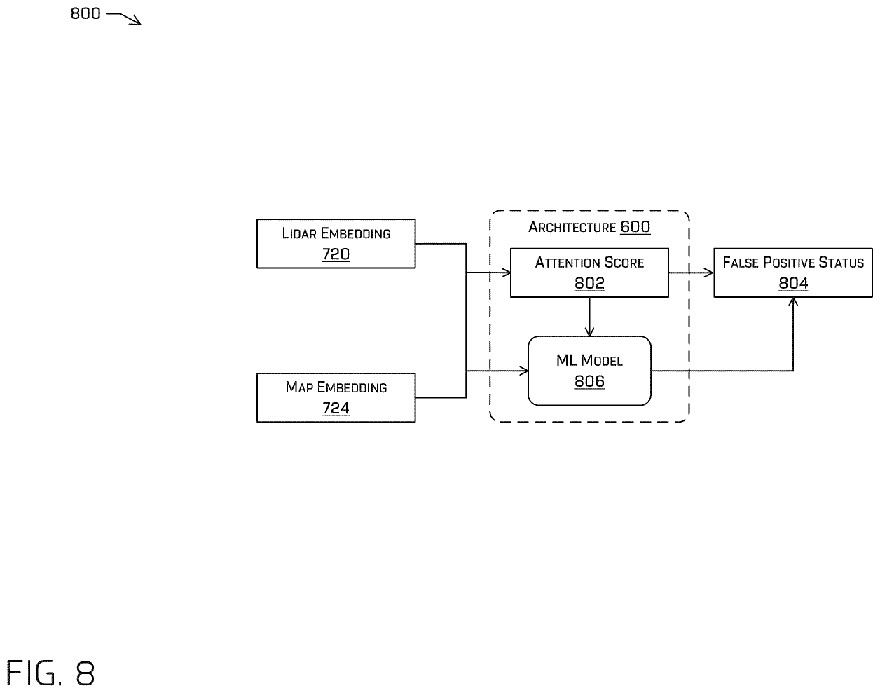

FIG. 8 illustrates a block diagram of an example architecture 800 of a remaining portion of the example transformer-based machine-learned model that may be used to determine a false positive status associated with an object. In some examples, example architecture 800 may be used in conjunction with example architecture 700. Example architecture 800 may include an architecture similar to example architecture 600. For example, the example architecture 800 may comprise first weight(s) that use lidar embedding 720 to generate a query and second weight(s) that use map embedding 724 to generate a key (e.g., by multiplying the weight(s) by the respective embeddings). The example architecture 800 may determine a dot product of the query and the key to determine an attention score 802, which may be used to determine a false positive status 804. In some examples, the attention score 802 may be scaled and softmaxed to determine an intermediate output that may be used to determine an attention matrix by determining a dot product of the intermediate output and values that may be determined by multiplying third weights by a set of map patches and embeddings. The attention matrix may be multiplied by the values to determine a context vector, which may be used in addition to or instead of the attention score 802 to determine the false positive status 804.

In some examples, to determine the false positive status 804, the example architecture 800 may determine if the attention score 802 (or an average attention score across multiple attention scores associated with different lidar patches associated with the lidar-based object detection 702) meets or exceeds a threshold attention score. If the attention score 802 meets or exceeds the threshold attention score, the false positive status 804 may indicate that the lidar-based object detection 702 is associated with a false positive dynamic object (if the object detection indicates a dynamic object, such as by detecting the mailbox as a dynamic object) or a true positive static detection (if the object detection indicates a static object, such as by detecting the mailbox as a static object). This may be the case because an attention score 802 that meets or exceeds the attention score threshold may indicate that the lidar patch and the map patch are highly correlated, meaning that the lidar-based object detection is likely associated with a static object indicated in the map data. Conversely, if the attention score 802 does not meet the attention score threshold, the false positive status 804 may indicate a true positive dynamic object (if the object detection indicates a dynamic object) or a false positive static detection (if the object detection indicates a static object). In an additional or alternate example, the attention score 802 and/or context vector may be provided as input to the ML model 806, which may determine a likelihood (e.g., a posterior probability) that the lidar-based object detection 702 is associated with a false positive dynamic object. In some examples, the ML model 806 may be a decoder comprise one or more layers of a multi-headed attention and add and normalization layer followed by a feed-forward network (e.g., a MLP).

### Example Training for the Transformer-Based Machine-Learned Model

The transformer-based machine-learned model discussed herein may comprise example architectures 300 and 600, 700 and 600, 700 and 800, or any combination thereof. Moreover, the transformer-based machine-learned model may comprise additional encoder and decoder portions configured according to the discussion herein with input nodes configured to receive sensor data from additional or alternate sensor modalities than those discussed (i.e., image data and lidar data). Training the transformer-based machine-learned model may comprise receiving training data that includes input data, such as sensor data and map data, and ground truth data associated with the outputs for which the transformer-based machine-learned model is being trained, such as a ground truth semantic segmentation, depth, false positive status, object detection, and/or Localization and/or mapping error. The training data may include sensor data that was previously received from the vehicle as part of log data and ground truth data associated therewith that may include perception data that was determined based on the sensor data that was generated by the vehicle and previously stored as part of log data. For example, the perception data may include a semantic segmentation, depth, object detection, etc. In an additional or alternate example, the ground truth data may be refined by human adjustment, an advanced ML model's adjustment, or may be generated by a human or advanced ML model. The advanced ML model may be one that may be larger and more complex than may normally run on a vehicle and/or may take advantage of advanced processing, such as by using distributed computing to leverage multiple computing device(s) to determine the ground truth data.

Regardless, training the transformer-based machine-learned model discussed herein may include determining a difference between an output of the transformer-based machine-learned model and the ground truth data. A loss (e.g., L1 loss, L2 loss, Huber loss, square root of the mean squared error, Cauchy loss, or another loss function), may be determined based on this difference and that loss may be backpropagated through the component(s) of architecture 800, architecture 700, architecture 600, and/or architecture 300. This means that parameter(s) of any of these components may be altered (using gradient descent) to reduce this loss such that, if the transformer-based machine-learned model repeated the process on the same input data, the resultant loss would be less than it was on the last run. This process may be repeated for multiple iterations of data, known as a training dataset. For example, the training may comprise altering one or more weights of the weight(s) that generate the queries, keys, and values discussed herein, parameter(s) of the multi-headed attention layers (of any of the encoder(s) and/or decoder(s)), weight(s) and/or biases associated with the feedforward network(s) discussed herein (of any of the encoder(s) and/or decoder(s)), and/or the embedding(s) themselves associated with the map data 308. However, in some examples, the embedding(s) associated with the map data 308 may be determined by a separate learned process as discussed regarding FIG. 9.

### Example Map Embedding Training

FIG. 9 illustrates a block diagram of an example architecture 900 comprising a transformer-based machine-learned model that generates embedding(s) to associate with geometric data 310 of the map data 308 for use in the techniques described herein. In some examples, using example architecture 900 to generate such embedding(s) to increase the embedding(s)' usefulness for the techniques discussed herein. This process may increase the accuracy of the outputs determined by the transformer-based machine-learned model discussed herein, such as the semantic segmentation, object detection, depth, false positive status, localization and/or mapping error, etc. In some examples, the example architecture 900 may determine the embedding(s) 312 as a first stage of training (i.e., pre-training) before the rest of the architectures discussed herein are trained, although, in some examples, example architecture 900 may iteratively update the embedding(s) 312 at various stages throughout training. In an example where architecture 900 is trained during a pre-training stage, the decoder 904 may be removed after pre-training and the encoder 902 and/or embedding(s) 312 may by altered based at least in part on training the other architectures discussed herein. Accordingly, the decoder 904 may be considered a training decoder.

The example architecture 900 may comprise an encoder 902 and a decoder 904. The encoder 902 may receive geometric data and/or feature(s) 906, which may comprise a portion of geometric data 310 and feature(s) associated therewith, such as text or encoded labels signifying a classification associated with the geometry data (e.g., crosswalk, junction, controlled/uncontrolled intersection, yield region, occluded region, direction of travel, sidewalk, passenger pickup/drop-off region, construction zone, park, school zone, speed limit region, construction zone indication, construction zone heat map), characteristic(s) (e.g., reflectivity, opacity, static coefficient, permeability, occlusion likelihood, and/or the like), and/or the like.

In some examples, training the example architecture 900 may comprise instantiating the embedding(s) 312 as tensors with random values. The encoder 902 may receive a portion geometric data and/or feature(s) 906 and may determine an embedding 312 associated therewith, modifying the original random embedding associated with the portion of geometric data and/or feature(s) 906 if this is the first time this embedding has been updated by the encoder 902 as part of training.

The training may be conducted such that decoder 904 may determine a reconstruction of geometric data and/or feature(s) 906, i.e., reconstruction of geometric data and/or feature(s) 908, based at least in part on the embedding 312. In other words, the decoder 904 is trained to determine a reconstruction that matches the originally input geometric data and/or feature(s) 906. Ideally, the reconstruction 908 and the geometric data and/or feature(s) 906 would be identical. Training the example architecture 900 may comprise determining a loss 910 (e.g., L1 loss, L2 loss, Huber loss, square root of the mean squared error, Cauchy loss, or another loss function) based on a difference between the reconstruction 908 and the geometric data and/or feature(s) 906. Gradient descent may then be used by altering parameter(s) of the encoder 902 and/or decoder 904 to reduce the loss.

In some examples, training the example architecture 900 may further comprise masking and/or removing a portion of the geometric data and/or feature(s) 906 provided as input to encoder 902. In some examples, the masking may be gradually introduced, i.e., the masking/removal may start at some point after the beginning of the training and, in some examples, may progressively increase. In some examples, masking may start from the beginning of training. Masking may comprise voiding, covering, or otherwise replacing portions of the geometric data and/or feature(s) 906 with nonce values or noise. For example, this may include masking portions of an image, text, or of a portion of the geometric data. Additionally or alternatively, masking may include the removal of part of a type of data or all of a type of data, such as all the image data, all the text data, or all the geometric data (or any portions thereof). Again, this removal may gradually increase as training epochs pass and/or as the training accuracy hits certain milestones, such as meeting or exceeding accuracy metric(s), such as by reducing the average loss below an average loss threshold.

In some examples, the process described above may be used as a pre-training step, after which the decoder 904 may be removed and the embedding(s) 312 and/or the encoder 902 may be trained using a loss determined for the transformer-based machine-learned model discussed above, comprising architecture(s) 300, 600, 700, and/or 800. In such an example, the differentiable rendering used to determine embedding gradients may be reversed after the outputs are determined and the embedding(s) 312 may be updated directly to reduce the loss and/or the encoder 902 may be modified by to reduce the loss determined based at least in part on an output of architecture(s) 600 and/or 800. In some examples, after this pre-training operation has been completed, the encoder 902 may be associated with a specific sensor modality and the training for encoder 902 may be sensor modality specific. In such an example, the embedding(s) 312 may be generated per sensor modality used. Although in an additional or alternate example, the reconstruction training may be suitable for all sensor modalities.

### Example Process to Determine Perception Data Using the Transformer-Based Machine-Learned Model

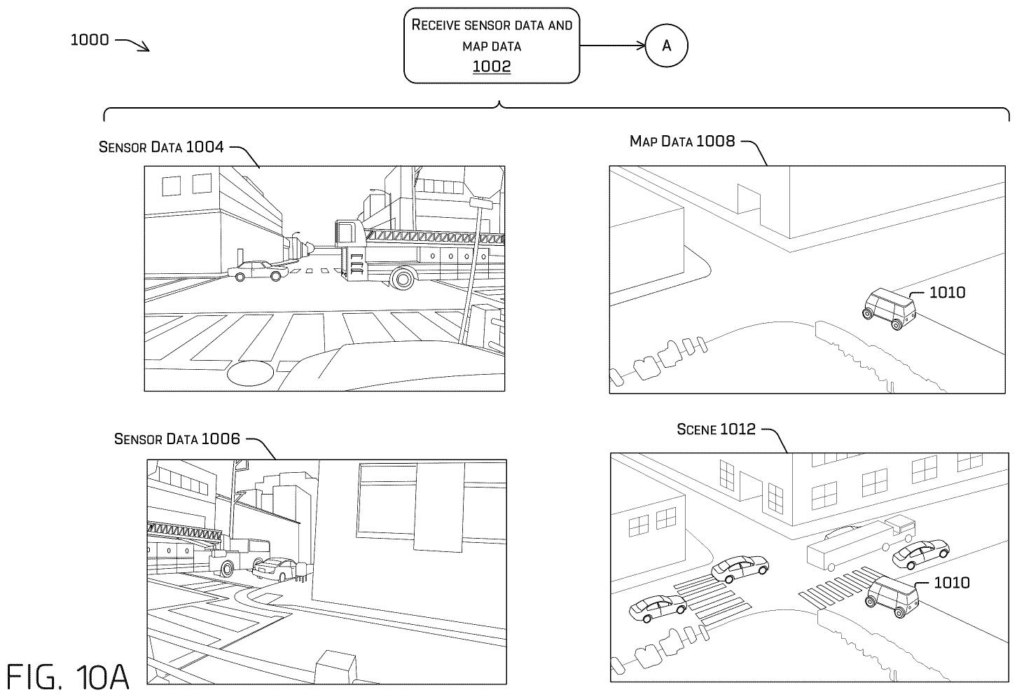

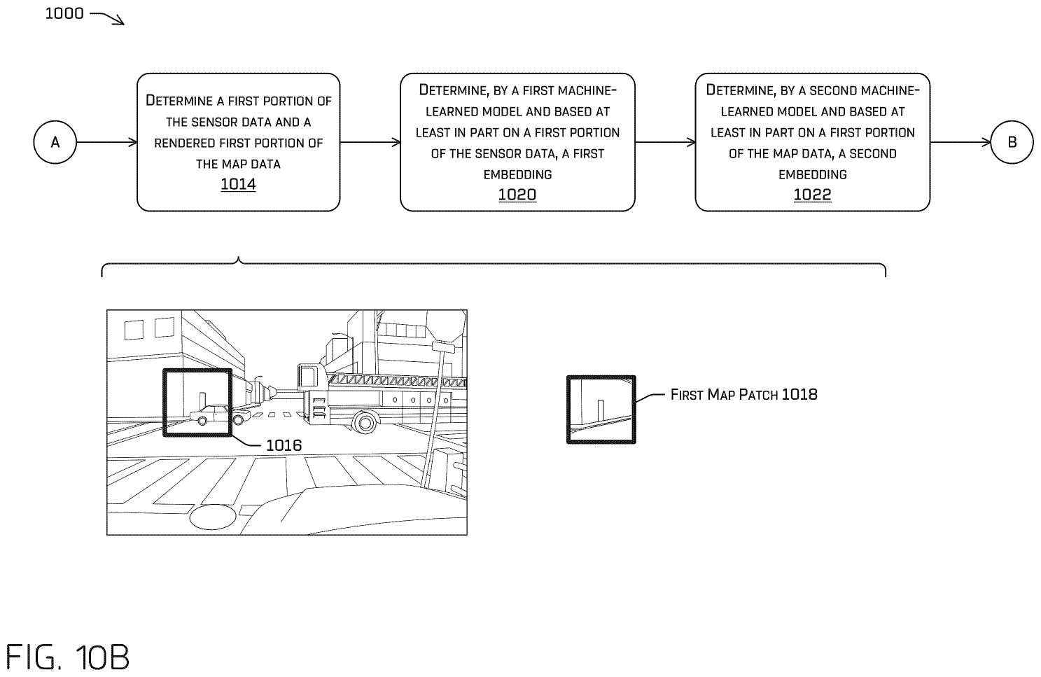

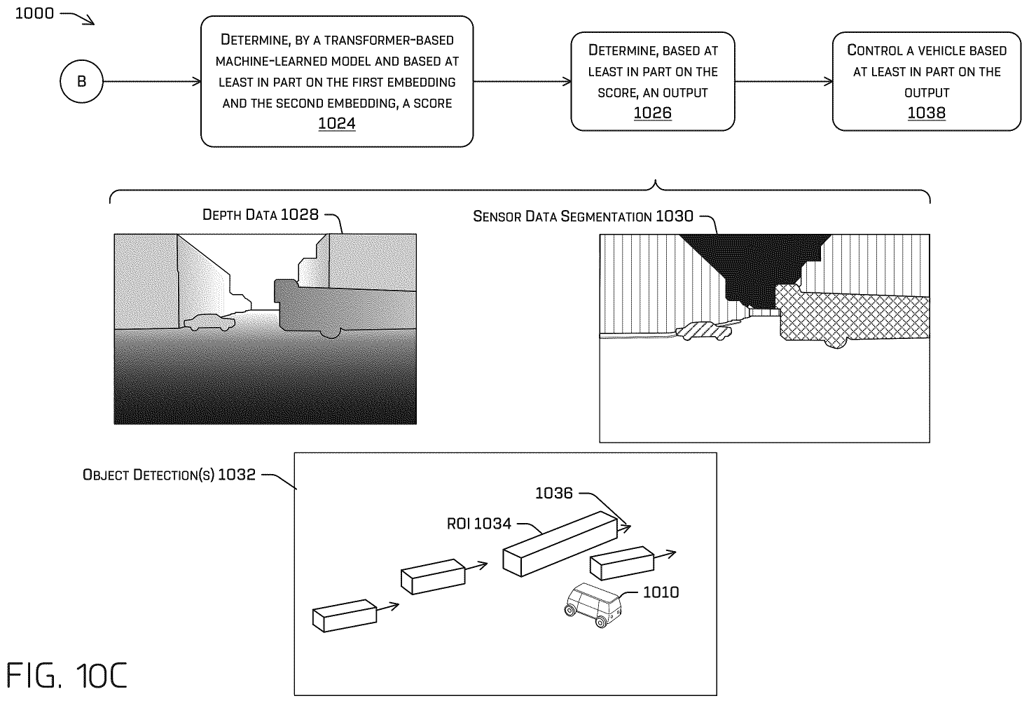

FIGS. 10A-10C illustrate a flow diagram of an example process 1000 for. In some examples, example process 1000 may be executed by the vehicle 202. At operation 1002, example process 1000 may comprise, according to any of the techniques discussed herein.

At operation 1002, example process 1000 may comprise receiving sensor data and map data, according to any of the techniques discussed herein. The sensor data may be any of the sensor data discussed herein, such as image data (e.g., visible light, infrared), lidar data, radar data, sonar data, microwave data, and/or the like, although the depictions for FIGS. 10A-10C include image data for the sake of simplicity. For example, the vehicle 202 may receive sensor data 1004 from a first sensor and sensor data 1006 from a second sensor. In some examples, the transformer-based machine-learned model discussed herein may batch or parallel process sensor data received from different sensors, although, in a lidar example, the sensor data may be aggregated into a point cloud, which may be used as input to the transformer-based machine-learned model, or, in another example, a mesh or other representation and/or an object may be determined based at least in part on the point cloud. For the sake of simplicity, the examples depicted and discussed herein regard sensor data 1004.

In some examples, the map data 1008 may comprise geometric data identifying shape(s) of surfaces in the environment and embedding(s) associated therewith. In some examples, the geometric data may be determined by SLAM based at least in part on sensor data and/or previously generated map data stored in a memory of the computer. For the sake of simplicity, the map data 1008 depicted in FIG. 10A only depicts geometric data associated with the scene 1012 and leaves out the embedding(s) associated therewith. The portion of map data 1008 retrieved may be based at least in part on a vehicle pose 1010 within the environment identifying a position and orientation of the vehicle relative to the environment. The vehicle 202 may use SLAM and sensor data to determine a vehicle and/or sensor pose in the environment and the corresponding pose in the map data 1008. Scene 1012 is depicted for the sake of illustration and comprehension of the scene. Note that the map data 1008 depicts static objects in the environment and may further indicate various features, as discussed above.

In some examples, operation 1002 may further comprise rendering an embedding-graded representation of the environment using the geometric data and embeddings associated therewith indicated by the map data 1008. As discussed above, rendering the embedding-graded representation may comprise differentiable rendering or any suitable technique for blending embeddings associated with different points or portions of the geometric data. This rendering may blend the embedding(s) associated with a portion of the geometric data, such as a face. A face may be associated with one or more embeddings. In at least one example, a face may be associated with at least three embeddings and the rendering may comprise blending these embeddings in association with the face, similar to how color might be rendered. In some examples, rendering the embedding-graded representation may comprise rendering a three-dimensional representation of the environment based at least in part on a vehicle sensor's perspective/field of view, which may be based on the vehicle pose 1010. In an additional or alternate example, a two-dimensional rendering of the embedding-graded representation may determined, such as a top-down view of the environment or a sensor view of the environment. For example, a top-down view may be used in examples where image data is projected into three-dimensional space by a machine-learned model or projected into a top-down view by a machine-learned model, or in an example where lidar data is projected into a top-down view.

Turning to FIG. 10B, at operation 1014, example process 1000 may comprise determining a first portion of the sensor data and a rendered first portion of the map data, according to any of the techniques discussed herein. Operation 1014 may comprise patchifying the sensor data into patches (which for three-dimensional data may include determining cuboids or other patchified portions thereof or rendering a two-dimensional version thereof and determining a cube or other patchified portion thereof) and patchifying the rendered map data into patches. In an example where the sensor data patches are three-dimensional, the map patches may also be three-dimensional and where the sensor data patches are three-dimensional determining the map patches may comprise projecting the rendered (embedding-graded) map data into a two-dimensional image (i.e., top-down if the sensor data is a top-down view or sensor view if the sensor data is left in its original view). The discussion herein follows a single image patch 1016 and the associated rendered first map patch 1018. Notably, the image patch 1016 contains a depiction of part of a vehicle, part of a building, and part of a roadway including a crosswalk region, whereas the first map patch 1018

Note that the first map patch 1018 does not include the embedding gradients for the sake of simplicity. The embedding gradients may normally show up as shading where the values (i.e., darkness/lightness) of shading is determined based at least in part on the embedding gradient. For example, a pixel in the first map patch 1018 may indicate a value associated with an embedding that is the result of blending two or more embeddings during the rendering. As such, the value may be a high-dimensional vector, which is not suitable for representation in two-dimensions and using a grayscale, which may be too limited in values to express the embedding since the embedding may be high dimensional (e.g., 10s, 100s, 1,000s of dimensions). Instead, the pixel may be associated with a vector that indicates values associated with the different dimensions of the embedding space. To use RGB color as an analogy, an RGB color value associated with a pixel has three dimensions a red channel, a green channel, and a blue channel, each of which may indicate a value from 0 to a maximum value that depends on how many bits are dedicated to each channel (e.g., typically 8 bits per channel for a total of 24-bits, allowing each channel to indicate a value between 0 and 255). The number of embedding channels may equal a number of dimensions of the embedding or the embedding channels may be quantized to reduce the number of channels (e.g., a first range of values in a first channel may indicate an embedding value in a first dimension of the embedding and a second range of values in the first channel may indicate an embedding value in a second dimension of the embedding).

At operation 1020, example process 1000 may comprise determining, by a first machine-learned model and based at least in part on a first portion of the sensor data, a first embedding, according to any of the techniques discussed herein. The first machine-learned model may comprise an encoder that generates the first embedding based at least in part on a sensor data patch, such as image patch 1016. Determining the first embedding may comprise projecting the image patch 1016 into an embedding space as determined by the encoder's trained parameters. In some examples, the machine-learned model may further comprise first weight(s) that may be multiplied by the first embedding to determine a query vector. For example, the first embedding and/or query vector may be associated with image patch 1016.

At operation 1022, example process 1000 may comprise determining, by a second machine-learned model and based at least in part on a first portion of the map data, a second embedding, according to any of the techniques discussed herein. The second machine-learned model may comprise an encoder that generates the second embedding based at least in part on a sensor data patch, such as first map patch 1018. Determining the second embedding may comprise projecting the first map patch 1018 into an embedding space as determined by the encoder's trained parameters. The embedding space may be a same embedding space as the embedding space into which the sensor data is projected or, in another example, the embedding spaces may be different. In some examples, the machine-learned model may further comprise second weight(s) that may be multiplied by the second embedding to determine a key vector. For example, the second embedding and/or key vector may be associated with image patch 1016.

Turning to FIG. 10C, at operation 1024, example process 1000 may comprise determining, by a transformer-based machine-learned model and based at least in part on the first embedding and the second embedding, a score, according to any of the techniques discussed herein. In some examples, the encoders that determined the first embedding and the second embedding may be part of the transformer-based machine-learned model. In some examples, determining the score may comprise determining the score by a decoder that projects the first embedding concatenated to the second embedding or an aggregated embedding into the score space, which may be indicated as a logit. An aggregated embedding may be determined by a feed forward network based on the first embedding and the second embedding or an additional encoder that projects the first embedding and second embedding into an aggregated embedding space as an aggregated embedding.

In an additional or alternate example, operation 1024 may include determining an attention score associated with the sensor data patch by determining a dot product of the query vector and the key vector (or transpose of the key vector). In some examples, this attention score itself may be used to determine one or more of the outputs discussed herein, although in additional or alternate examples, the attention score may be used to determine a context vector for determining one or more of the outputs discussed herein, as discussed in more detail regarding FIG. 3.

At operation 1026, example process 1000 may comprise determining, based at least in part on the score, an output, according to any of the techniques discussed herein. For example, the output may include at least one of a semantic segmentation, instance segmentation, object detection, depth, localization and/or mapping error, false positive status, and/or the like. Any one of these outputs may be associated with its own decoder that determines the output based at least in part on the attention score, context vector, and/or values determined by multiplying third weight(s) and the map patches or sensor data patches, an example that uses self-attention. Such a decoder may use attention scores and/or context vectors across entire sensor or for just a portion of the sensor data, such as for a patch, to project the vector into the output space. For example, the output space may comprise logits associated with semantic labels associated with the map features for semantic segmentation; logits, a quantized range of distances, or a raw distance for a depth output; ROI scalars (to scale the size of an anchor ROI) and/or a likelihood associated with an ROI for an object detection output; a logit or raw value associated with object velocity for an object detection output; a logit associated with a quantized range of headings or a raw heading for an object detection output; a probability of an error or a quantity of error for a localization and/or mapping error; a logit indicating a likelihood that a dynamic object detection is a false positive dynamic object detection for a false positive status output; and/or the like.

In an additional or alternate example, an attention score may be used in combination with an attention score threshold to determine one or more of the described outputs. For example, an attention score (associated with a sensor data patch) that meets or exceeds an attention score threshold may be used to:
indicate that no dynamic object is depicted in a sensor data patch,
associate a label associated with a map feature with the sensor data patch,
indicate that a dynamic object detection is a false positive dynamic object detection,
indicate that a static object detection is a true positive static object detection,
associate one or more depths with the map patch (by determining the portion of the map data associated with the map patch and the distance in three-dimensional space from the sensor to that portion of the map data), and/or the like.

An attention score (associated with the sensor data patch) that does not meet the attention score threshold may be used to:
indicate that a dynamic object is depicted in the sensor data patch and/or suppress association of a map label with the sensor data patch,
indicate that a dynamic object detection is a true positive dynamic object detection,
indicate that a static object detection is a false positive static object detection, and/or the like.

FIG. 10C depicts a few examples of these outputs, such as depth data 1028, which indicates depth as a function of grayscale. Note that, in some examples, the depth data may be associated with static objects, although in some examples, the transformer-based machine-learned model may be able to output a depth associated with dynamic objects. Other illustrated examples of these outputs include a sensor data segmentation 1030 with different classifications of objects shown in different hashing/shading. For example, the sensor data identified by the sensor data segmentation 1030 as being associated with the ground plane is shown in white, the sky is depicted in black, a passenger vehicle is depicted in hashing, and an oversized vehicle is depicted in cross-hatching. The depicted examples further include depictions of object detection(s) 1032, illustrated as ROIs associated with different object positions and/or headings and arrows to indicate heading and/or velocity. For example, the object detection(s) 1032 include an object detection associated with the oversized vehicle (the fire truck) and includes ROI 1034 and arrow 1036. As discussed above, object detection(s) may include additional or alternate data, such as object classification, object state, acceleration, and/or the like. It is understood that 1028-1036 are merely depictions for the sake of understanding and that the outputs determined by the transformer-based machine-learned model may be in encoded as machine code, a data structure, or the like.

At operation 1038, example process 1000 may comprise controlling an autonomous vehicle based at least in part on any of the outputs determined at operation 1026, according to any of the techniques discussed herein. For example, the planning component 114 may determine a route for the vehicle 102 from a first location to a second location; generate, substantially simultaneously and based at least in part on any of the outputs, a plurality of potential trajectories for controlling motion of the vehicle 102 in accordance with a receding horizon technique (e.g., a time horizon (e.g., 5 milliseconds, 10 milliseconds, 100 milliseconds, 200 milliseconds, 0.5 seconds, 1 second, 2 seconds, etc.) or a distance horizon (e.g., 1 meter, 2 meters, 5 meters, 8 meters, 10 meters)) to control the vehicle to traverse the route (e.g., in order to avoid any of the detected objects); and select one of the potential trajectories as a trajectory of the vehicle 102 that may be used to generate a drive control signal that may be transmitted to drive components of the vehicle 102. In another example, the planning component 114 may determine other controls based at least in part on any of the outputs determined at operation 1026, such as whether to open or close a door of the vehicle, activate an emitter of the vehicle, or the like.

### EXAMPLE CLAUSES

A: A system comprising: one or more processors; and non-transitory memory storing processor-executable instructions that, when executed by the one or more processors, cause the system to perform operations comprising: receiving sensor data associated with an environment surrounding a vehicle; determining map data associated with the environment based at least in part on a first pose of the vehicle and a second pose of a sensor associated with the vehicle; determining, by a first encoder based at least in part on at least a first portion of the sensor data, a first embedding; determining, by a second encoder based at least in part on a first portion of the map data, a second embedding, wherein the first portion of the sensor data and the first portion of the map data are associated with a region of the environment; determining, by a transformer-based machine-learned model comprising the first encoder and the second encoder and based at least in part on the first embedding and the second embedding, a score indicating a relationship between the first portion of the sensor data and the first portion of the map data; determining, based at least in part on the score, an output comprising at least one of a semantic segmentation associated with the sensor data, an object detection indicating a detection of an object represented in the sensor data, a depth to the object, or a false positive dynamic object indication; and controlling the vehicle based at least in part on the output.

B: The system of paragraph A, wherein determining the score comprises: determining a query vector based at least in part on multiplying the first embedding with a first set of learned weights; determining a key vector based at least in part on multiplying the second embedding with a second set of learned weights; and determining a first dot product between the query vector and the key vector.

C: The system of paragraph B, wherein the output comprises the semantic segmentation and determining the semantic segmentation based at least in part on the score comprises at least one of: determining to associate a semantic label with the first portion of the sensor data based at least in part on determining that the score meets or exceeds a threshold score; or determining a value matrix based at least in part on multiplying the second embedding with a third set of learned weights; determining a context vector based at least in part on determining a second dot product of the score and the value matrix; and determining, by a decoder or a threshold value and based at least in part on the context vector, the semantic label to associated with the first portion of the sensor data.

D: The system of either paragraph B or C, wherein the output comprises the detection and determining the detection based at least in part on the score comprises at least one of: determining that the first dot product does not meet a threshold; or determining a value matrix based at least in part on multiplying the second embedding with a third set of learned weights; determining a context vector based at least in part on determining a second dot product of the score and the value matrix; and determining, by a decoder based at least in part on the context vector, the object detection.

E: The system of any one of paragraphs B-D, wherein: the operations further comprise receiving a dynamic object detection associated with a first sensor, the dynamic object detection indicating existence of a dynamic object in the environment based on first sensor data received from the first sensor; the output comprises the false positive dynamic object indication indicating that the object detection is a false positive dynamic object; and determining the false positive dynamic object indication comprises determining that the first dot product meets or exceeds a threshold.

F: The system of any one of paragraphs B-E, wherein the output comprises the depth and determining the depth based at least in part on the score comprises: determining that the first dot product meets or exceeds a threshold; determining a surface associated with the first portion of the map data; and associating a distance from a position of a sensor to the surface with the first portion of the sensor data as the depth.

G: One or more non-transitory computer-readable media storing processor-executable instructions that, when executed by one or more processors, perform operations comprising: receiving sensor data; receiving map data associated with a portion of an environment associated with the sensor data; determining, by a first machine-learned model based at least in part on the sensor data, a first embedding; determining, by a second machine-learned model based at least in part on the map data, a second embedding; determining, based at least in part on the first embedding and the second embedding, an output comprising at least one of a semantic segmentation associated with the sensor data, an object detection indicating a detection of an object represented in the sensor data, a depth to the object, a localization error, or a false positive indication; and controlling a vehicle based at least in part on the output.

H: The one or more non-transitory computer-readable media of paragraph G, wherein: the operations further comprise determining, by a transformer-based machine-learned model and based at least in part on the first embedding and the second embedding, a score indicating a relationship between the sensor data and the map data; determining the output is based at least in part on the score; and determining the score comprises: determining a query vector based at least in part on multiplying the first embedding with a first set of learned weights; determining a key vector based at least in part on multiplying the second embedding with a second set of learned weights; and determining a first dot product between the query vector and the key vector.

I: The one or more non-transitory computer-readable media of paragraph H, wherein the output comprises the semantic segmentation and determining the semantic segmentation based at least in part on the score comprises at least one of: determining to associate a semantic label with the sensor data based at least in part on determining that the score meets or exceeds a threshold score; or determining a value matrix based at least in part on multiplying the second embedding with a third set of learned weights; determining a context vector based at least in part on determining a second dot product of the score and the value matrix; and determining, by a decoder or a threshold value and based at least in part on the context vector, the semantic label to associated with the sensor data.

J: The one or more non-transitory computer-readable media of either paragraph H or I, wherein the output comprises the detection and determining the detection based at least in part on the score comprises at least one of: determining that the first dot product does not meet a threshold; or determining a value matrix based at least in part on multiplying the second embedding with a third set of learned weights; determining a context vector based at least in part on determining a second dot product of the score and the value matrix; and determining, by a decoder based at least in part on the context vector, the object detection.

K: The one or more non-transitory computer-readable media of any one of paragraphs H-J, wherein: the operations further comprise receiving a dynamic object detection associated with a first sensor, the dynamic object detection indicating existence of a dynamic object in the environment based on first sensor data received from the first sensor; the output comprises the false positive indication indicating that the object detection is a false positive dynamic object; and determining the false positive indication comprises determining that the first dot product meets or exceeds a threshold.

L: The one or more non-transitory computer-readable media of any one of paragraphs H-K, wherein the output comprises the depth and determining the depth based at least in part on the score comprises: determining that the first dot product meets or exceeds a threshold; determining a surface associated with the map data; and associating a distance from a position of a sensor to the surface with the sensor data as the depth.

M: The one or more non-transitory computer-readable media of any one of paragraphs G-L, wherein: determining the output comprises determining, by a decoder based at least in part on the first embedding and the second embedding, the output; the first machine-learned model comprises a first encoder; and the second machine-learned model comprises a second encoder.

N: The one or more non-transitory computer-readable media of any one of paragraphs G-M, wherein the map data comprises geometric data and a third embedding associated with the geometric data and the operations further comprise: receiving training data indicating ground truth associated with the output; determining a loss based at least in part on a difference between the ground truth and the output; and altering the third embedding to reduce the loss.

O: The one or more non-transitory computer-readable media of paragraph N, wherein: the first machine-learned model comprises a first encoder; the second machine-learned model comprises a second encoder; a third encoder determines the third embedding and the operations further comprise a pre-training stage that comprises: determining, by the third encoder based at least in part on a portion of the geometric data and a feature associated therewith, a training embedding determining, by a training decoder based at least in part on the training embedding, a reconstruction of the portion of the geometric data and the feature; determining a second loss based at least in part on a difference between the reconstruction and the geometric data and the feature; and altering at least one of the third encoder, the training embedding, or the training decoder to reduce the second loss.

P: A method comprising: receiving sensor data; receiving map data associated with a portion of an environment associated with the sensor data; determining, by a first machine-learned model based at least in part on the sensor data, a first embedding; determining, by a second machine-learned model based at least in part on the map data, a second embedding; determining, based at least in part on the first embedding and the second embedding, an output comprising at least one of a semantic segmentation associated with the sensor data, an object detection indicating a detection of an object represented in the sensor data, a depth to the object, a localization error, or a false positive indication; and controlling a vehicle based at least in part on the output.

Q: The method of paragraph P, wherein: the method further comprises determining, by a transformer-based machine-learned model and based at least in part on the first embedding and the second embedding, a score indicating a relationship between the sensor data and the map data; determining the output is based at least in part on the score; and determining the score comprises: determining a query vector based at least in part on multiplying the first embedding with a first set of learned weights; determining a key vector based at least in part on multiplying the second embedding with a second set of learned weights; and determining a first dot product between the query vector and the key vector.

R: The method of paragraph Q, wherein at least one of: the output comprises the semantic segmentation and determining the semantic segmentation based at least in part on the score comprises at least one of: determining to associate a semantic label with the sensor data based at least in part on determining that the score meets or exceeds a threshold score; or determining a value matrix based at least in part on multiplying the second embedding with a third set of learned weights; determining a context vector based at least in part on determining a second dot product of the score and the value matrix; and determining, by a decoder or a threshold value and based at least in part on the context vector, the semantic label to associated with the sensor data; or the output comprises the detection and determining the detection based at least in part on the score comprises at least one of: determining that the first dot product does not meet a threshold; or determining a value matrix based at least in part on multiplying the second embedding with a third set of learned weights; determining a context vector based at least in part on determining a second dot product of the score and the value matrix; and determining, by a decoder based at least in part on the context vector, the object detection; or the method further comprises receiving a dynamic object detection associated with a first sensor, the dynamic object detection indicating existence of a dynamic object in the environment based on first sensor data received from the first sensor; the output comprises the false positive indication indicating that the object detection is a false positive dynamic object; and determining the false positive indication comprises determining that the first dot product meets or exceeds a threshold.

S: The method of either paragraph Q or R, wherein the output comprises the depth and determining the depth based at least in part on the score comprises: determining that the first dot product meets or exceeds a threshold; determining a surface associated with the map data; and associating a distance from a position of a sensor to the surface with the sensor data as the depth.

T: The method of any one of paragraphs P-S, wherein: the map data comprises geometric data and a third embedding associated with the geometric data; the first machine-learned model comprises a first encoder; the second machine-learned model comprises a second encoder; a third encoder determines the third embedding and and the method further comprises: receiving training data indicating ground truth associated with the output; determining a loss based at least in part on a difference between the ground truth and the output; altering the third embedding to reduce the loss; and the method further comprises a pre-training stage that comprises: determining, by the third encoder based at least in part on a portion of the geometric data and a feature associated therewith, a training embedding determining, by a training decoder based at least in part on the training embedding, a reconstruction of the portion of the geometric data and the feature; determining a second loss based at least in part on a difference between the reconstruction and the geometric data and the feature; and altering at least one of the third encoder, the training embedding, or the training decoder to reduce the second loss.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

elements or functions may be deleted, or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
non-transitory memory storing processor-executable instructions that, when executed by the one or more processors, cause the system to perform operations comprising:
receiving sensor data associated with an environment surrounding a vehicle;
determining map data associated with the environment based at least in part on a first pose of the vehicle and a second pose of a sensor associated with the vehicle;
determining, by a first encoder based at least in part on at least a first portion of the sensor data, a first embedding;
determining, by a second encoder based at least in part on a first portion of the map data, a second embedding, wherein the first portion of the sensor data and the first portion of the map data are associated with a region of the environment;
determining, by a transformer-based machine-learned model comprising the first encoder and the second encoder and based at least in part on the first embedding and the second embedding, a score indicating a relationship between the first portion of the sensor data and the first portion of the map data;
determining, based at least in part on the score, an output comprising at least one of a semantic segmentation associated with the sensor data, an object detection indicating a detection of an object represented in the sensor data, a depth to the object, or a false positive dynamic object indication; and
controlling the vehicle based at least in part on the output.

2. The system of claim 1, wherein determining the score comprises:
determining a query vector based at least in part on multiplying the first embedding with a first set of learned weights;
determining a key vector based at least in part on multiplying the second embedding with a second set of learned weights; and
determining a first dot product between the query vector and the key vector.

3. The system of claim 2, wherein the output comprises the semantic segmentation and determining the semantic segmentation based at least in part on the score comprises at least one of:
determining to associate a semantic label with the first portion of the sensor data based at least in part on determining that the score meets or exceeds a threshold score; or
determining a value matrix based at least in part on multiplying the second embedding with a third set of learned weights;
determining a context vector based at least in part on determining a second dot product of the score and the value matrix; and
determining, by a decoder or a threshold value and based at least in part on the context vector, the semantic label to associated with the first portion of the sensor data.

4. The system of claim 2, wherein the output comprises the detection and determining the detection based at least in part on the score comprises at least one of:
determining that the first dot product does not meet a threshold; or
determining a value matrix based at least in part on multiplying the second embedding with a third set of learned weights;
determining a context vector based at least in part on determining a second dot product of the score and the value matrix; and
determining, by a decoder based at least in part on the context vector, the object detection.

5. The system of claim 2, wherein:
the operations further comprise receiving a dynamic object detection associated with a first sensor, the dynamic object detection indicating existence of a dynamic object in the environment based on first sensor data received from the first sensor;
the output comprises the false positive dynamic object indication indicating that the object detection is a false positive dynamic object; and
determining the false positive dynamic object indication comprises determining that the first dot product meets or exceeds a threshold.

6. The system of claim 2, wherein the output comprises the depth and determining the depth based at least in part on the score comprises:
determining that the first dot product meets or exceeds a threshold;
determining a surface associated with the first portion of the map data; and
associating a distance from a position of a sensor to the surface with the first portion of the sensor data as the depth.

7. One or more non-transitory computer-readable media storing processor-executable instructions that, when executed by one or more processors, perform operations comprising:
receiving sensor data;
receiving map data associated with a portion of an environment associated with the sensor data;
determining, by a first machine-learned model based at least in part on the sensor data, a first embedding;
determining, by a second machine-learned model based at least in part on the map data, a second embedding;
determining, based at least in part on the first embedding and the second embedding, an output comprising at least one of a semantic segmentation associated with the sensor data, an object detection indicating a detection of an object represented in the sensor data, a depth to the object, a localization error, or a false positive indication; and
controlling a vehicle based at least in part on the output.

8. The one or more non-transitory computer-readable media of claim 7, wherein:
the operations further comprise determining, by a transformer-based machine-learned model and based at least in part on the first embedding and the second embedding, a score indicating a relationship between the sensor data and the map data;
determining the output is based at least in part on the score; and
determining the score comprises:
determining a query vector based at least in part on multiplying the first embedding with a first set of learned weights;
determining a key vector based at least in part on multiplying the second embedding with a second set of learned weights; and
determining a first dot product between the query vector and the key vector.

9. The one or more non-transitory computer-readable media of claim 8, wherein the output comprises the semantic segmentation and determining the semantic segmentation based at least in part on the score comprises at least one of:
determining to associate a semantic label with the sensor data based at least in part on determining that the score meets or exceeds a threshold score; or
determining a value matrix based at least in part on multiplying the second embedding with a third set of learned weights;
determining a context vector based at least in part on determining a second dot product of the score and the value matrix; and
determining, by a decoder or a threshold value and based at least in part on the context vector, the semantic label to associated with the sensor data.

10. The one or more non-transitory computer-readable media of claim 8, wherein the output comprises the detection and determining the detection based at least in part on the score comprises at least one of:
determining that the first dot product does not meet a threshold; or
determining a value matrix based at least in part on multiplying the second embedding with a third set of learned weights;
determining a context vector based at least in part on determining a second dot product of the score and the value matrix; and
determining, by a decoder based at least in part on the context vector, the object detection.

11. The one or more non-transitory computer-readable media of claim 8, wherein:
the operations further comprise receiving a dynamic object detection associated with a first sensor, the dynamic object detection indicating existence of a dynamic object in the environment based on first sensor data received from the first sensor;
the output comprises the false positive indication indicating that the object detection is a false positive dynamic object; and
determining the false positive indication comprises determining that the first dot product meets or exceeds a threshold.

12. The one or more non-transitory computer-readable media of claim 8, wherein the output comprises the depth and determining the depth based at least in part on the score comprises:
determining that the first dot product meets or exceeds a threshold;
determining a surface associated with the map data; and
associating a distance from a position of a sensor to the surface with the sensor data as the depth.

13. The one or more non-transitory computer-readable media of claim 7, wherein:
determining the output comprises determining, by a decoder based at least in part on the first embedding and the second embedding, the output;
the first machine-learned model comprises a first encoder; and
the second machine-learned model comprises a second encoder.

14. The one or more non-transitory computer-readable media of claim 7, wherein the map data comprises geometric data and a third embedding associated with the geometric data and the operations further comprise:
receiving training data indicating ground truth associated with the output;
determining a loss based at least in part on a difference between the ground truth and the output; and
altering the third embedding to reduce the loss.

15. The one or more non-transitory computer-readable media of claim 14, wherein:
the first machine-learned model comprises a first encoder;
the second machine-learned model comprises a second encoder;
a third encoder determines the third embedding and the operations further comprise a pre-training stage that comprises:
determining, by the third encoder based at least in part on a portion of the geometric data and a feature associated therewith, a training embedding
determining, by a training decoder based at least in part on the training embedding, a reconstruction of the portion of the geometric data and the feature;
determining a second loss based at least in part on a difference between the reconstruction and the geometric data and the feature; and
altering at least one of the third encoder, the training embedding, or the training decoder to reduce the second loss.

16. A method comprising:
receiving sensor data;
receiving map data associated with a portion of an environment associated with the sensor data;
determining, by a first machine-learned model based at least in part on the sensor data, a first embedding;
determining, by a second machine-learned model based at least in part on the map data, a second embedding;
determining, based at least in part on the first embedding and the second embedding, an output comprising at least one of a semantic segmentation associated with the sensor data, an object detection indicating a detection of an object represented in the sensor data, a depth to the object, a localization error, or a false positive indication; and
controlling a vehicle based at least in part on the output.

17. The method of claim 16, wherein:
the method further comprises determining, by a transformer-based machine-learned model and based at least in part on the first embedding and the second embedding, a score indicating a relationship between the sensor data and the map data;
determining the output is based at least in part on the score; and
determining the score comprises:
determining a query vector based at least in part on multiplying the first embedding with a first set of learned weights;
determining a key vector based at least in part on multiplying the second embedding with a second set of learned weights; and
determining a first dot product between the query vector and the key vector.

18. The method of claim 17, wherein at least one of:
the output comprises the semantic segmentation and determining the semantic segmentation based at least in part on the score comprises at least one of:
determining to associate a semantic label with the sensor data based at least in part on determining that the score meets or exceeds a threshold score;
or
determining a value matrix based at least in part on multiplying the second embedding with a third set of learned weights;
determining a context vector based at least in part on determining a second dot product of the score and the value matrix; and
determining, by a decoder or a threshold value and based at least in part on the context vector, the semantic label to associated with the sensor data; or
the output comprises the detection and determining the detection based at least in part on the score comprises at least one of:
determining that the first dot product does not meet a threshold; or
determining a value matrix based at least in part on multiplying the second embedding with a third set of learned weights;
determining a context vector based at least in part on determining a second dot product of the score and the value matrix; and
determining, by a decoder based at least in part on the context vector, the object detection;
or
the method further comprises receiving a dynamic object detection associated with a first sensor, the dynamic object detection indicating existence of a dynamic object in the environment based on first sensor data received from the first sensor;
the output comprises the false positive indication indicating that the object detection is a false positive dynamic object; and
determining the false positive indication comprises determining that the first dot product meets or exceeds a threshold.

19. The method of claim 17, wherein the output comprises the depth and determining the depth based at least in part on the score comprises:
determining that the first dot product meets or exceeds a threshold;
determining a surface associated with the map data; and
associating a distance from a position of a sensor to the surface with the sensor data as the depth.

20. The method of claim 16, wherein:
the map data comprises geometric data and a third embedding associated with the geometric data;
the first machine-learned model comprises a first encoder;
the second machine-learned model comprises a second encoder;
a third encoder determines the third embedding and and the method further comprises:
receiving training data indicating ground truth associated with the output;
determining a loss based at least in part on a difference between the ground truth and the output;
altering the third embedding to reduce the loss; and
the method further comprises a pre-training stage that comprises:
determining, by the third encoder based at least in part on a portion of the geometric data and a feature associated therewith, a training embedding
determining, by a training decoder based at least in part on the training embedding, a reconstruction of the portion of the geometric data and the feature;
determining a second loss based at least in part on a difference between the reconstruction and the geometric data and the feature; and
altering at least one of the third encoder, the training embedding, or the training decoder to reduce the second loss.
